(19) United States
(12) Patent Application Publication
(10) Pub. No.: US 2026/0029729 A1
(43) Pub. Date: Jan. 29, 2026

(54) ELECTROSTATIC CHARGE IMAGE DEVELOPER SET, IMAGE FORMING APPARATUS, AND IMAGE FORMING METHOD

(71) Applicant: FUJIFILM Business Innovation Corp., Tokyo (JP)

(72) Inventors: Ryo NAGAI, Kanagawa (JP); Yasuo KADOKURA, Kanagawa (JP); Yosuke TSURUMI, Kanagawa (JP); Moegi IGUCHI, Kanagawa (JP)

(73) Assignee: FUJIFILM Business Innovation Corp., Tokyo (JP)

(21) Appl. No.: 19/056,150

(22) Filed: Feb. 18, 2025

(30) Foreign Application Priority Data
Jul. 24, 2024 (JP) 2024-118935

(51) Int. Cl. G03G 9/107; G03G 9/113; G03G 15/01

(52) U.S. Cl. CPC G03G 9/107; G03G 9/1132; G03G 9/1139; G03G 15/0121; G03G 15/0126; G03G 2215/0624

(57) ABSTRACT

An electrostatic charge image developer set includes a developer (1) and a developer (2) each containing a toner and a carrier, in which a carrier (1) of the developer (1) includes magnetic particles, a resin coating layer that covers the magnetic particles, and inorganic particles contained in the resin coating layer, a carrier (2) of the developer (2) includes magnetic particles and a resin coating layer that covers the magnetic particles, and a value of A(1)/A(2) is 17 or more and 105 or less, where when an element ratio of a metal and a semimetal that constitute the inorganic particles of the carrier (1) is analyzed by X-ray photoelectron spectroscopy for each of the carrier (1) and the carrier (2), an element ratio on a surface of the carrier (1) is denoted as A(1) and an element ratio on a surface of the carrier (2) is denoted as A(2).

### CROSS-REFERENCE TO RELATED APPLICATIONS

This application is based on and claims priority under 35 USC 119 from Japanese Patent Application No. 2024-118935 filed Jul. 24, 2024.

### BACKGROUND

### (i) Technical Field

The present disclosure relates to an electrostatic charge image developer set, an image forming apparatus, and an image forming method.

### (ii) Related Art

Japanese Unexamined Patent Application Publication No. 2022-147733 discloses a carrier for electrostatic charge image development including magnetic particles and a coating resin layer containing silica particles, in which the ratio of Si on the surface of the coating resin layer is 6 atom % or more and 12 atom % or less as determined by X-ray photoelectron spectroscopy.

Japanese Unexamined Patent Application Publication No. 2007-219321 discloses a two-component developer containing toner particles and carrier particles, in which the toner particles contain at least a binder resin, a colorant, a charge controlling agent, and an external additive, the carrier particles have a coating layer formed of a resin, the film thickness of the coating layer is such that the color carrier film thickness d_{c} is smaller than the black carrier film thickness d_{bk}, and the carrier resistance value of the carrier for color is the same as that of the carrier for black or is 10⁻² Ω·cm or less.

### SUMMARY

Aspects of non-limiting embodiments of the present disclosure relate to an electrostatic charge image developer set that suppresses the occurrence of filming on the surface of an image holding member located downstream in a tandem-type image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic charge image developer set including a developer (1) and a developer (2) each containing a toner and a carrier, in which a carrier (1) of the developer (1) includes magnetic particles, a resin coating layer that covers the magnetic particles, and inorganic particles contained in the resin coating layer, a carrier (2) of the developer (2) includes magnetic particles and a resin coating layer that covers the magnetic particles, and a value of A(1)/A(2) is 17 or more and 105 or less, where when an element ratio of a metal and a semimetal that constitute the inorganic particles of the carrier (1) is analyzed by X-ray photoelectron spectroscopy for each of the carrier (1) and the carrier (2), an element ratio on a surface of the carrier (1) is denoted as A(1) and an element ratio on a surface of the carrier (2) is denoted as A(2).

### BRIEF DESCRIPTION OF THE DRAWINGS

Exemplary embodiments of the present disclosure will be described in detail based on the following FIGURE, wherein:

FIG. 1 is a schematic configuration diagram illustrating an example of an image forming apparatus according to the present exemplary embodiment.

### DETAILED DESCRIPTION

Hereinafter, exemplary embodiments of the present disclosure will be described. The description of these and Examples are illustrative of exemplary embodiments and are not intended to limit the scope of the exemplary embodiments.

In the present disclosure, a numerical range indicated by using “to” indicates a range including the numerical values before and after “to” as the minimum and maximum values, respectively.

In the numerical ranges described stepwise in the present disclosure, the upper limit value or lower limit value described in one numerical range may be replaced with the upper limit value or lower limit value of another numerical range described stepwise. In a numerical range described in the present disclosure, the upper limit value or lower limit value in the numerical range may be replaced with a value presented in Examples.

In the present disclosure, “A and/or B” is synonymous with “at least one of A and B”. In other words, it means that “A and/or B” may be only A, may be only B, or may be a combination of A and B.

In the present disclosure, the term “step” includes not only an independent step but also a step that cannot be clearly distinguished from another step as long as the purpose of the step is achieved.

When an exemplary embodiment of the present disclosure is described with reference to the drawings, the configuration of the exemplary embodiment is not limited to the configuration illustrated in the drawings. The sizes of the members in the respective drawings are conceptual, and the relative relation in size between the members is not limited thereto.

In the present disclosure, each component may contain a plurality of kinds of corresponding substances. In the present disclosure, when referring to the amount of each component in a composition, in a case where a plurality of kinds of substances corresponding to each component are present in the composition, the amount means the total amount of the plurality of kinds of substances present in the composition unless otherwise stated.

In the present disclosure, particles corresponding to each component may include a plurality of kinds. In a case where a plurality of kinds of particles corresponding to each component are present in a composition, the particle size of each component means a value for a mixture of the plurality of kinds of particles present in the composition unless otherwise stated.

In the present disclosure, when a compound is represented by a structural formula, the compound may be represented by a structural formula in which symbols (C and H) representing a carbon atom and a hydrogen atom in a hydrocarbon group and/or a hydrocarbon chain are omitted.

In the present disclosure, the term “(meth)acryl” is an expression that includes both acryl and methacryl, and the term “(meth)acrylate” is an expression that includes both an acrylate and a methacrylate.

In the present disclosure, the “developer set” refers to an “electrostatic charge image developer set”, the “developer” refers to an “electrostatic charge image developer”, the “carrier” refers to a “carrier for electrostatic charge image development”, and the “toner” refers to a “toner for electrostatic charge image development”.

### Electrostatic Charge Image Developer Set

The developer set of the present disclosure is a set of a developer (1) and a developer (2) each containing a toner and a carrier. In other words, each of the developer (1) and the developer (2) is a two-component developer.

In the present disclosure, the toner constituting the developer (1) is referred to as “toner (1)”, and the carrier constituting the developer (1) is referred to as “carrier (1)”.

In the present disclosure, the toner constituting the developer (2) is referred to as “toner (2)”, and the carrier constituting the developer (2) is referred to as “carrier (2)”.

The developer (1) is a two-component developer in which the toner (1) and the carrier (1) are mixed at an appropriate blending proportion. The mixing ratio (mass ratio) of the toner (1) to the carrier (1) is preferably toner (1):carrier (1)=1:100 to 30:100, more preferably 3:100 to 20:100.

The developer (2) is a two-component developer in which the toner (2) and the carrier (2) are mixed at an appropriate blending proportion. The mixing ratio (mass ratio) of the toner (2) to the carrier (2) is preferably toner (2):carrier (2)=1:100 to 30:100, more preferably 3:100 to 20:100.

The carrier (1) of the developer (1) includes magnetic particles, a resin coating layer that covers the magnetic particles, and inorganic particles contained in the resin coating layer. Regarding the resin coating layer of the carrier (1), carbon black is not inorganic particles.

The carrier (2) of the developer (2) includes magnetic particles and a resin coating layer that covers the magnetic particles. Regarding the resin coating layer of the carrier (2), carbon black is not inorganic particles.

In the developer set of the present disclosure, the value of A(1)/A(2) is 17 or more and 105 or less, where when an element ratio of a metal and a semimetal that constitute the inorganic particles of the carrier (1) is analyzed by X-ray photoelectron spectroscopy for each of the carrier (1) and the carrier (2), an element ratio on a surface of the carrier (1) is denoted as A(1) and an element ratio on a surface of the carrier (2) is denoted as A(2).

The “inorganic particles” of the “metals and semimetals that constitute the inorganic particles”, which are the analysis targets of the X-ray photoelectron spectroscopy according to the carrier (1) and the carrier (2), are the inorganic particles contained in the resin coating layer of the carrier (1). In the carrier (2) as well, the element ratio of the metals and semimetals that constitute the inorganic particles contained in the resin coating layer of the carrier (1) is analyzed.

In a case where the carrier (2) does not contain inorganic particles in the resin coating layer, the A(2) value derived from the carrier (2) itself is zero, but the inorganic particles (for example, silica particles, alumina particles, and titania particles), which are external additives of the toner (2), are attached to the surface of the carrier (2) in some cases, and thus the value of A(2) is not zero in some cases.

The developer set of the present disclosure is applied to a tandem-type image forming apparatus. The developer (1) is used in the image forming unit located on the upstream side of the tandem-type image forming apparatus, and the developer (2) is used in the image forming unit located on the downstream side.

In the related art, when the image forming apparatus is used for a long period of time, the cleaning member of the image holding member deteriorates, the surface of the image holding member is not sufficiently cleaned, and filming (a phenomenon in which a toner component forms a coating film) occurs on the surface of the image holding member in some cases. Particularly in a tandem-type image forming apparatus, filming occurs on the surface of the image holding member located downstream in some cases.

In contrast, the developer set of the present disclosure suppresses the occurrence of filming on the surface of the image holding member located downstream in a tandem-type image forming apparatus.

In a tandem-type image forming apparatus, the carrier (1) contained in the developer (1) used by the image forming unit (1) located upstream is mixed into the developer (2) used by the image forming unit (2) located downstream in some cases. The migration pathway of the carrier (1) at this time is as follows.

The carrier (1) contained in the developer (1) is mixed into a toner image (1) formed on the image holding member (1) by the developer (1). The toner image (1) in which the carrier (1) is mixed is transferred from the image holding member (1) to a transfer target (for example, an intermediate transfer body of an intermediate transfer system or a recording medium of a direct transfer system). When a toner image (2) on an image holding member (2) is transferred to the transfer target, the carrier (1) mixed in the toner image (1) is transferred from the transfer target to the image holding member (2). The carrier (1) migrated to the image holding member (2) is migrated from the image holding member (2) to the developing device (2) and mixed into the developer (2).

In the event in which the carrier (1) is mixed into the developer (2), it is presumed that the developer set of the present disclosure suppresses the occurrence of filming on the surface of the image holding member (2) by the following mechanism.

The carrier (1) is provided with fine irregularities as the inorganic particles are properly exposed on the surface of the resin coating layer, and has lower surface energy than the carrier (2). When this carrier (1) is mixed in the developer (2), a magnetic brush is formed by both the carrier (1) having relatively low surface energy and the carrier (2) having relatively high surface energy in the developing device (2). According to the relative difference in surface energy, the carrier (1) is more easily detached from the magnetic brush than the carrier (2), and is easily migrated to the image holding member (2). It is considered that the carrier (1) is particularly selectively migrated to the image holding member (2) in a form in which a small amount of the carrier (1) is mixed in the carrier (2) rather than a form in which predetermined amounts of the carrier (1) and the carrier (2) are mixed from the beginning. Then, the carrier (1) reaches the cleaning nip portion of the image holding member (2), and the carrier (1) containing the inorganic particles in the resin coating layer exerts a polishing effect to remove filming on the surface of the image holding member (2).

When the value of A(1)/A(2) of the developer set is less than 17, the difference in surface energy between the carrier (1) and the carrier (2) is so small that selective migration of the carrier (1) from the magnetic brush formed in the developing device (2) to the image holding member (2) hardly occurs, and filming occurs on the surface of the image holding member (2) in some cases. Therefore, the value of A(1)/A(2) of the developer set is 17 or more, preferably 25 or more, more preferably 30 or more.

When the value of A(1)/A(2) of the developer set is more than 105, the surface energy of the carrier (1) itself is so small that the carrier (1) hardly migrates from the transfer target to the image holding member (2) and the developing device (2), and the polishing action of the carrier (1) in the image holding member (2) cannot be expected, and filming occurs on the surface of the image holding member (2) in some cases. Therefore, the value of A(1)/A(2) of the developer set is 105 or less, preferably 80 or less, more preferably 60 or less.

The element ratio A(1) related to the surface of the carrier (1) has the same meaning as the element ratio A(1) at the etching time of 0 seconds described later, and the measurement method and the preferable numerical values are also the same.

The element ratio A(2) related to the surface of the carrier (2) has the same meaning as the element ratio A(2) at the etching time of 0 seconds described later, and the measurement method and the preferable numerical values are also the same.

Hereinafter, the carrier (1), the carrier (2), the toner (1), and the toner (2) will be described in detail.

### Carrier (1)

The carrier (1) includes magnetic particles, a resin coating layer that covers the magnetic particles, and inorganic particles contained in the resin coating layer.

### Value of B(1)−A(1)

It is preferable that the value of B(1)−A(1) in the carrier (1) is 0.5 atm % or more and 3.0 atm % or less, where when the element ratio of the metals and semimetals that constitute the inorganic particles contained in the resin coating layer is analyzed in the depth direction by X-ray photoelectron spectroscopy, the element ratio at an etching time of 0 seconds is denoted as A(1) and the element ratio at an etching time of 300 seconds is denoted as B(1).

The value of B(1)−A(1) is preferably 0.8 atm % or more and 2.7 atm % or less, more preferably 1.0 atm % or more and 2.5 atm % or less, still more preferably 1.2 atm % or more and 2.3 atm % or less from the viewpoint of suppressing the occurrence of filming on the surface of the image holding member located downstream in a tandem-type image forming apparatus.

The element analysis in the depth direction by X-ray photoelectron spectroscopy (XPS) and the measurement method of the element ratio A(1) and the element ratio B(1) are as follows.

The carrier (1) is separated from the developer (1). Examples of the method for separating the carrier include a method in which the toner is taken off from the developer by air blowing using an arbitrary mesh.

The carrier (1) is used as a sample for XPS, and an element is analyzed while etching is performed. The elements to be analyzed are carbon, nitrogen, oxygen, iron, manganese, and the metals and semimetals that constitute the inorganic particles. In a case where the metals and semimetals that constitute the inorganic particles are unknown, analysis of all elements of the carrier (1) is performed in advance to identify the metals and semimetals that constitute the inorganic particles. Examples of the metal elements constituting the inorganic particles include aluminum and titanium. Examples of the semimetal elements constituting the inorganic particles include silicon, boron, germanium, arsenic, antimony, and tellurium.

The proportion of the total element amount of the metals and semimetals that constitute the inorganic particles to the total element amount of all the elements, which are the analysis targets, is taken as an element ratio (atm %) of the metals and semimetals that constitute the inorganic particles. In other words, the element ratio (atm %) of metals and semimetals that constitute inorganic particles=(total element amount of metals and semimetals that constitute inorganic particles)/(total element amount of carbon, nitrogen, oxygen, iron, manganese, and metals and semimetals that constitute inorganic particles)×100.

The element ratio at the etching time of 0 seconds is A(1) (atm %), and the element ratio at an etching time of 300 seconds is B(1) (atm %). The etching time of 0 seconds means that etching is not yet performed.

The XPS is performed using the following instrument under the following conditions. The analysis is performed after baseline correction.
XPS instrument: PHI5000 Versa ProbeII (ULVAC-PHI, INCORPORATED)
X-ray source: Monochromatized AlKα rays
Beam voltage: 15 kV
Emission current: 3 mA
Etching gun: Argon gas cluster ion gun
Vacuum degree: 1×10⁻⁵ Pa to 1×10⁻⁶ Pa
Pass Energy: 23.5 eV
Sweep region: 300 μm×300 μm
Time Per Step: 50 seconds
Cycle: 5 cycles
Sweep: 10 times

### Value of Element Ratio A(1)

The value of the element ratio A(1) is preferably 2.0 atm % or more and 10.0 atm % or less, more preferably 2.5 atm % or more and 8.0 atm % or less, still more preferably 3.0 atm % or more and 6.0 atm % or less from the viewpoint of suppressing the occurrence of filming on the surface of the image holding member located downstream in a tandem-type image forming apparatus.

### Value of Element Ratio B(1)

The value of the element ratio B(1) is preferably 3.5 atm % or more and 12.0 atm % or less, more preferably 4.3 atm % or more and 9.8 atm % or less, still more preferably 4.8 atm % or more and 7.8 atm % or less from the viewpoint of suppressing the occurrence of filming on the surface of the image holding member located downstream in a tandem-type image forming apparatus.

### Method for Controlling Value of B(1)−A(1)

The value of B(1)−A(1) can be controlled, for example, by utilizing the sedimentation phenomenon and/or Brazil nut phenomenon of particles when the resin coating layer is formed.

The sedimentation phenomenon of particles is a phenomenon in which the sedimentation velocity of particles varies depending on the particle size and shape of particles, the density difference and affinity between particles and a dispersion medium, the density difference and affinity between particles and other components, the particle concentration, and the like. In general, the sedimentation velocity of particles in a liquid is faster as the particle size is smaller and the density is higher. The Brazil nut phenomenon is a phenomenon in which particles having a large particle size rise when vibration is applied to an aggregate of a plurality of kinds of particles having different particle sizes.

When the resin coating layer is formed by a wet process, particles can freely move in a liquid in which a resin is dissolved, and therefore, the phenomena can be utilized.

By utilizing the phenomena, the value of B(1)−A(1) is controlled by the material, particle size, and density and/or concentration of the inorganic particles, the presence or absence of addition of other particles, the kind of the resin of the resin coating layer, the formation conditions of the resin coating layer, and the like.

When the particle size of the inorganic particles is set in an appropriate range, the inorganic particles are likely to be properly unevenly distributed on the lower side of the resin coating layer. As particles having a larger particle size than the inorganic particles are used in combination as the other particles, the inorganic particles are more likely to be unevenly distributed on the lower side of the resin coating layer. When the other particles are particles having a lower density than the inorganic particles and/or particles having a polarity different from that of the inorganic particles, the inorganic particles are more likely to be unevenly distributed on the lower side of the resin coating layer. When the concentration of the inorganic particles is set in an appropriate range, the inorganic particles are likely to be properly unevenly distributed on the lower side of the resin coating layer. When the concentration of the other particles is set in an appropriate range as well, the inorganic particles are likely to be properly unevenly distributed on the lower side of the resin coating layer.

### Resin Coating Layer

### Resin

The carrier (1) has a resin coating layer on the surface of magnetic particles.

Examples of the resin constituting the resin coating layer include styrene-acrylic acid copolymers; polyolefin-based resins such as polyethylene and polypropylene; polyvinyl-based or polyvinylidene-based resins such as polystyrene, acrylic resins, polyacrylonitrile, polyvinyl acetate, polyvinyl alcohol, polyvinyl butyral, polyvinyl chloride, polyvinyl carbazole, polyvinyl ether and polyvinyl ketone; vinyl chloride-vinyl acetate copolymers; straight silicone resins having organosiloxane bonds or modified products thereof, fluororesins such as polytetrafluoroethylene, polyvinyl fluoride, polyvinylidene fluoride and polychlorotrifluoroethylene; polyesters; polyurethanes; polycarbonates; amino resins such as urea-formaldehyde resins; and epoxy resins.

These resins may be used singly or in combination of two or more kinds thereof.

From the viewpoint of controlling the value of B(1)−A(1), the resin coating layer preferably contains an acrylic resin having an alicyclic structure and an amino group, and more preferably contains an acrylic resin having a constitutional unit having an alicyclic structure and a constitutional unit having an amino group.

The alicyclic structure is preferably a cycloalkyl group, more preferably a cyclohexyl group.

Examples of the acrylic resin having a cyclohexyl group include a homopolymer of a (meth)acrylic monomer having a cyclohexyl group, and a copolymer of a (meth)acrylic monomer having a cyclohexyl group and another monomer. Examples of the (meth)acrylic monomer having a cyclohexyl group include cyclohexyl acrylate and cyclohexyl methacrylate.

As the constitutional unit having an alicyclic structure, a constitutional unit derived from cyclohexyl (meth)acrylate is preferable.

The acrylic resin having a constitutional unit having an alicyclic structure preferably contains the constitutional unit having an alicyclic structure at 80% by mass or more.

As the (meth)acrylic monomer having an amino group, a dialkylaminoalkyl (meth)acrylate is preferable, and dimethylaminoethyl (meth)acrylate is more preferable.

The acrylic resin having a constitutional unit having an amino group contains the constitutional unit having an amino group at preferably 0.05% by mass or more and 5% by mass or less, more preferably 0.1% by mass or more and 2% by mass or less.

### Inorganic Particles

The resin coating layer contains inorganic particles.

Examples of the inorganic particles include particles of metal compounds such as silica (silicon dioxide), titania (titanium oxide), alumina (aluminum oxide), zinc oxide, tin oxide, barium sulfate, aluminum borate, potassium titanate, antimony-doped tin oxide, tin-doped indium oxide, and aluminum-doped zinc oxide; particles of metals such as gold, silver, and copper; and resin particles covered with a metal.

The inorganic particles may be used singly or in combination of two or more kinds thereof.

The inorganic particles are preferably at least one selected from the group consisting of silica particles, titania particles, and alumina particles, more preferably silica particles from the viewpoint of exhibiting excellent dispersibility in the resin and being likely to exert an effect of preventing an abnormal increase or decrease in charging by proper appearance of the inorganic particles on the surface.

The average primary particle size of the inorganic particles is preferably 1 nm or more and 100 nm or less, more preferably 5 nm or more and 60 nm or less, still more preferably 5 nm or more and 40 nm or less, still more preferably 6 nm or more and 30 nm or less, particularly preferably 7 nm or more and 20 nm or less from the viewpoint of suppressing the occurrence of filming on the surface of the image holding member located downstream in a tandem-type image forming apparatus.

When the average primary particle size of the inorganic particles is 1 nm or more, the inorganic particles are less likely to aggregate when the resin coating layer is formed, and as a result, the inorganic particles are likely to be unevenly distributed on the lower side of the resin coating layer.

When the average primary particle size of the inorganic particles is 100 nm or less, exposure of the inorganic particles to the surface of the resin coating layer is suppressed.

In the present disclosure, the primary particle size of the inorganic particles is the diameter of a circle having the same area as the primary particle image (so-called equivalent circle diameter), and the average primary particle size of the inorganic particles is a particle size at which the cumulative percentage from the small size side in the number-based distribution of the primary particle size is 50%. The primary particle size of the inorganic particles is determined by image analysis of at least 300 inorganic particles.

The inorganic particles contained in the resin coating layer may be inorganic particles themselves, or may be particles obtained by subjecting the surfaces of inorganic particles (also referred to as base particles) to hydrophobization treatment. The inorganic particles are preferably inorganic particles subjected to surface treatment, more preferably inorganic particles whose surfaces have been subjected to hydrophobization treatment from the viewpoint that the effect of preventing aggregation of the inorganic particles is great and the effect of preventing an abnormal increase or decrease in charging is likely to be exerted by the enhancement in affinity for the resin of the resin coating layer and proper appearance of the inorganic particles on the surface.

The surface treatment of the inorganic particles is performed by, for example, preparing a treatment liquid obtained by mixing a silicon-containing organic compound that is a hydrophobizing agent and a solvent, mixing the inorganic particles and the treatment liquid while stirring is performed, and further continuously performing stirring. After the surface treatment, drying treatment is performed for the purpose of removing the solvent of the treatment liquid.

Examples of the silicon-containing organic compound used for the surface treatment of the inorganic particles include an alkoxysilane compound, a silazane compound, and silicone oil. Among these, an alkoxysilane compound or a silazane compound is preferable and a silazane compound is more preferable from the viewpoint that an effect of improving dispersibility of the inorganic particles and preventing aggregation of the inorganic particles is obtained by proper steric hindrance, and as a result, an effect of preventing an abnormal increase or decrease in charging is likely to be exerted by proper appearance of the inorganic particles on the surface.

Examples of the alkoxysilane compound used for hydrophobization treatment of the surface of the inorganic particles include tetramethoxysilane, tetraethoxysilane; methyltrimethoxysilane, ethyltrimethoxysilane, propyltrimethoxysilane, butyltrimethoxysilane, hexyltrimethoxysilane, N-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; trimethylmethoxysilane, and trimethylethoxysilane.

Examples of the silazane compound used for hydrophobization treatment of the surface of the inorganic particles include dimethyldisilazane, trimethyldisilazane, tetramethyldisilazane, pentamethyldisilazane, and hexamethyldisilazane.

Examples of the silicone oil used for the surface treatment of the inorganic particles include silicone oil such as dimethylpolysiloxane, diphenylpolysiloxane, and phenylmethylpolysiloxane; and reactive silicone oil such as amino-modified polysiloxane, epoxy-modified polysiloxane, carboxyl-modified polysiloxane, carbinol-modified polysiloxane, fluorine-modified polysiloxane, methacrylic-modified polysiloxane, mercapto-modified polysiloxane, and phenol-modified polysiloxane.

The solvent used in the preparation of the treatment liquid is preferably an alcohol (for example, methanol, ethanol, propanol, or butanol) in a case where the silicon-containing organic compound is an alkoxysilane compound or a silazane compound, and is preferably a hydrocarbon (for example, benzene, toluene, normal hexane, or normal heptane) in a case where the silicon-containing organic compound is silicone oil.

In the treatment liquid, the concentration of the silicon-containing organic compound is preferably 1% by mass or more and 50% by mass or less, more preferably 5% by mass or more and 40% by mass or less, still more preferably 10% by mass or more and 30% by mass or less.

The amount of the silicon-containing organic compound used for the surface treatment is preferably 1 part by mass or more and 50 parts by mass or less, more preferably 5 parts by mass or more and 40 parts by mass or less, still more preferably 5 parts by mass or more and 30 parts by mass or less with respect to 100 parts by mass of the inorganic particles.

The content of the inorganic particles in the resin coating layer is preferably 15% by mass or more and 35% by mass or less, more preferably 17% by mass or more and 30% by mass or less, still more preferably 20% by mass or more and 25% by mass or less with respect to the entire mass of the resin coating layer. When the content of the inorganic particles is in the above range, the inorganic particles are likely to be properly unevenly distributed on the lower side of the resin coating layer.

In the carrier (1), the ratio (element ratio A(1)/content of inorganic particles, atm %/mass %) of the amount (element ratio A(1), atm %) of the inorganic particles on the carrier surface to the content (mass %) of the inorganic particles in the resin coating layer is preferably 0.05 or more and 0.60 or less, more preferably 0.08 or more and 0.40 or less, still more preferably 0.10 or more and 0.30 or less. The fact that the ratio of the amount (element ratio A(1), atm %) of the inorganic particles on the carrier surface to the content (mass %) of the inorganic particles in the resin coating layer is in the above range indicates that the carrier surface becomes properly hard by the inorganic particles and the inorganic particles are properly unevenly distributed on the lower side of the resin coating layer.

### Resin Particles

The resin coating layer preferably contains resin particles from the viewpoint of suppressing the occurrence of filming on the surface of the image holding member located downstream in a tandem-type image forming apparatus.

Examples of the resin particles include particles of a (meth)acrylic resin obtained by polymerization to contain dimethylaminoethyl (meth)acrylate, dimethylacrylamide, acrylonitrile, or the like; an amino resin such as urea, melamine, guanamine, or aniline; an amide resin; a urethane resin; and any copolymer of the resins. The resin particles may be used singly or in combination of two or more kinds thereof.

The resin particles are preferably at least one selected from the group consisting of acrylic resin particles, amino resin particles, and urethane resin particles, are more preferably amino resin particles, and still more preferably include melamine resin particles.

Since the polarity of the melamine resin particles is different from that of the inorganic particles, it is considered that the Brazil nut phenomenon acts more.

The average primary particle size of the resin particles is preferably 100 nm or more and 400 nm or less, more preferably 150 nm or more and 350 nm or less from the viewpoint of suppressing the occurrence of filming on the surface of the image holding member located downstream in a tandem-type image forming apparatus.

When the average primary particle size of the resin particles is in the above range, the difference in particle size between the resin particles and the inorganic particles is proper and the inorganic particles are likely to be unevenly distributed on the lower side of the resin coating layer.

In the present disclosure, the primary particle size of the resin particles is the diameter of a circle having the same area as the primary particle image (so-called equivalent circle diameter), and the average primary particle size of the resin particles is the particle size at which the cumulative percentage from the small size side in the number-based distribution of the primary particle size is 50%. The primary particle size of the resin particles is determined by image analysis of at least 300 resin particles.

The value of the ratio D1/D2 of the average primary particle size D1 of the inorganic particles contained in the resin coating layer to the average primary particle size D2 of the resin particles is preferably 0.01 or more and 0.15 or less, more preferably 0.02 or more and 0.10 or less.

When the value of the ratio D1/D2 is in the above range, the difference in particle size between the inorganic particles and the resin particles is proper and the inorganic particles are likely to be unevenly distributed on the lower side of the resin coating layer.

The value of the density ratio between the inorganic particles and the resin particles (density of inorganic particles/density of resin particles) is preferably 1.0 or more and 5.0 or less. When the density ratio is in the above range, a difference in the degree of sedimentation in a liquid is likely to appear when the resin coating layer is formed by a wet process, and the inorganic particles are likely to be disposed on the lower side of the resin coating layer.

The content of the resin particles in the resin coating layer is preferably lower than the content of the inorganic particles from the viewpoint of suppressing the occurrence of filming on the surface of the image holding member located downstream in a tandem-type image forming apparatus.

The content of the resin particles in the resin coating layer is preferably 5% by mass or more and 30% by mass or less, more preferably 6% by mass or more and 20% by mass or less, still more preferably 7% by mass or more and 15% by mass or less with respect to the entire mass of the resin coating layer from the viewpoint of suppressing the occurrence of filming on the surface of the image holding member located downstream in a tandem-type image forming apparatus.

### Carbon Black

The resin coating layer preferably contains carbon black from the viewpoint of suppressing the occurrence of filming on the surface of the image holding member located downstream in a tandem-type image forming apparatus.

The average primary particle size of carbon black is preferably 10 nm or more and 70 nm or less, more preferably 20 nm or more and 60 nm or less, still more preferably 30 nm or more and 50 nm or less from the viewpoint of suppressing the occurrence of filming on the surface of the image holding member located downstream in a tandem-type image forming apparatus.

The value of the ratio D1/D3 of the average primary particle size D1 of the inorganic particles contained in the resin coating layer to the average primary particle size D3 of carbon black is preferably 0.1 or more and 1.0 or less.

When the value of the ratio D1/D3 is in the above range, the difference in particle size between the inorganic particles and carbon black is proper, the Brazil nut phenomenon is likely to occur, carbon black floats on the upper side of the resin coating layer when the resin coating layer is formed by a wet process, and as a result, the inorganic particles are likely to be disposed on the lower side of the resin coating layer.

The value of the density ratio between the inorganic particles and carbon black (density of inorganic particles/density of carbon black) is preferably 1.0 or more and 5.0 or less. When the density ratio is in the above range, a difference in the degree of sedimentation in a liquid is likely to appear when the resin coating layer is formed by a wet process, and the inorganic particles are likely to be disposed on the lower side of the resin coating layer.

The content of carbon black in the resin coating layer is preferably lower than the content of the inorganic particles in the resin coating layer from the viewpoint of suppressing the occurrence of filming on the surface of the image holding member located downstream in a tandem-type image forming apparatus.

The content of carbon black in the resin coating layer is preferably lower than the content of the resin particles in the resin coating layer from the viewpoint of suppressing the occurrence of filming on the surface of the image holding member located downstream in a tandem-type image forming apparatus.

The content of carbon black in the resin coating layer is preferably 0.5% by mass or more and 15% by mass or less, more preferably 1% by mass or more and 13% by mass or less, still more preferably 2% by mass or more and 10% by mass or less with respect to the entire mass of the resin coating layer from the viewpoint of suppressing the occurrence of filming on the surface of the image holding member located downstream in a tandem-type image forming apparatus.

The resin coating layer preferably contains silica particles and melamine resin particles and more preferably contains silica particles, melamine resin particles, and carbon black from the viewpoint of suppressing the occurrence of filming on the surface of the image holding member located downstream in a tandem-type image forming apparatus.

The resin coating layer of the carrier (1) preferably contains a nitrogen atom-containing resin. Examples of the nitrogen atom-containing resin include a binder resin and/or resin particles.

The nitrogen atom-containing binder resin is preferably an acrylic resin having a constitutional unit having an amino group, and the (meth)acrylic monomer having an amino group is preferably a dialkylaminoalkyl (meth)acrylate, more preferably dimethylaminoethyl (meth)acrylate.

The nitrogen atom-containing resin particles are preferably amino resin particles, more preferably melamine resin particles.

When the mass proportion of the nitrogen atom-containing resin to the entire mass of the resin coating layer of the carrier (1) is denoted as R(1), the value of R(1) is preferably 2% by mass or more and 25% by mass or less, more preferably 5% by mass or more and 23% by mass or less, still more preferably 8% by mass or more and 22% by mass or less.

### Method for Forming Resin Coating Layer

Examples of the method for forming the resin coating layer on the magnetic particle surface include a wet process and a dry process. The wet process is a production process using a solvent for dissolving or dispersing the resin constituting the resin coating layer, and is preferable from the viewpoint that disposition of the inorganic particles can be controlled by utilizing a sedimentation phenomenon or a Brazil nut phenomenon.

Examples of the wet process include a dipping method in which the magnetic particles are covered by being dipped in a resin liquid for resin coating layer formation; a spraying method in which a resin liquid for resin coating layer formation is sprayed on the magnetic particle surface; a fluidized bed method in which a resin liquid for resin coating layer formation is sprayed in a state where the magnetic particles are fluidized in a fluidized bed; and a kneader coater method in which the magnetic particles and the resin liquid for resin coating layer formation are mixed in a kneader coater and the solvent is removed.

The resin liquid for resin coating layer formation used in the wet process is prepared by dissolving or dispersing a resin and other components in a solvent. The solvent is not particularly limited as long as it dissolves or disperses the resin, and for example, aromatic hydrocarbons such as toluene and xylene; ketones such as acetone and methyl ethyl ketone; and ethers such as tetrahydrofuran and dioxane are used.

In Examples described later, the resin coating layer is formed in a plurality of steps by a wet process, but the method for forming the resin coating layer is not limited thereto.

The thickness of the resin coating layer is preferably 0.5 μm or more and 2.0 μm or less, more preferably 0.7 μm or more and 1.4 μm or less.

### Magnetic Particles

The magnetic particles are not particularly limited, and known magnetic particles used as a core material of a carrier are applied. Specific examples of the magnetic particles include particles of a magnetic metal such as iron, nickel, or cobalt; particles of a magnetic oxide such as ferrite or magnetite; resin-impregnated magnetic particles in which a porous magnetic powder is impregnated with a resin; and magnetic powder-dispersed resin particles in which a magnetic powder is blended by being dispersed in a resin.

In the present disclosure, ferrite particles are suitable as the magnetic particles.

In the present disclosure, the ferrite particles preferably contain at least one selected from calcium oxide and strontium oxide. Calcium oxide and strontium oxide are likely to be contained in the surface of the ferrite particles, and it is presumed that the leakage of charges from the ferrite particles is suppressed and the carrier surface is relatively highly charged when calcium element or strontium element is present on the surface of the ferrite particles. According to this carrier, low charging of the toner in the developing device is suppressed, and as a result, fogging is further suppressed, and further, fine line reproducibility is improved (for example, thickening, breaking, or blurring of fine lines is suppressed). This effect is remarkable when high-concentration and high-density monochromatic image formation is repeated at a higher speed and then a low-density image of the same color is formed.

In the present disclosure, the ferrite particles contain at least one selected from calcium oxide and strontium oxide, and the total content of calcium element and strontium element is preferably 0.1% by mass or more and 2.0% by mass or less with respect to the entire mass of the ferrite particles. When the total content of calcium element and strontium element is 0.1% by mass or more with respect to the entire mass of the ferrite particles, charge leakage from the ferrite particles is efficiently suppressed. When the total content of calcium element and strontium element is 2.0% by mass or less with respect to the entire mass of the ferrite particles, the crystal structure of the ferrite particles is arranged, and the resistance value and the magnetic susceptibility are in appropriate ranges. As a result, fogging is further suppressed, and further fine line reproducibility is improved (for example, thickening, breaking, or blurring of fine lines is suppressed).

From the above viewpoints, the total content of calcium element and strontium element is preferably 0.1% by mass or more and 2.0% by mass or less, more preferably 0.2% by mass or more and 1.5% by mass or less, still more preferably 0.5% by mass or more and 1.2% by mass or less with respect to the entire mass of the ferrite particles.

In the present disclosure, it is preferable that the ferrite particles contain a calcium oxide and the content of calcium element is 0.2% by mass or more and 2.0% by mass or less with respect to the entire mass of the ferrite particles. When the content of calcium element is 0.2% by mass or more with respect to the entire mass of the ferrite particles, charge leakage from the ferrite particles is efficiently suppressed. When the content of calcium element is 2.0% by mass or less with respect to the entire mass of the ferrite particles, the crystal structure of the ferrite particles is arranged, and the resistance value and the magnetic susceptibility are in appropriate ranges. As a result, fogging is further suppressed, and further fine line reproducibility is improved (for example, thickening, breaking, or blurring of fine lines is suppressed).

From the above viewpoints, the content of calcium element is preferably 0.2% by mass or more and 2.0% by mass or less, more preferably 0.5% by mass or more and 1.5% by mass or less, still more preferably 0.5% by mass or more and 1.0% by mass or less with respect to the entire mass of the ferrite particles.

In the present disclosure, it is preferable that the ferrite particles contain a strontium oxide and the content of strontium element is 0.1% by mass or more and 1.0% by mass or less with respect to the entire mass of the ferrite particles. When the content of strontium element is 0.1% by mass or more with respect to the entire mass of the ferrite particles, charge leakage from the ferrite particles is efficiently suppressed. When the content of strontium element is 1.0% by mass or less with respect to the entire mass of the ferrite particles, the crystal structure of the ferrite particles is arranged, and the resistance value and the magnetic susceptibility are in appropriate ranges. As a result, fogging is further suppressed, and further fine line reproducibility is improved (for example, thickening, breaking, or blurring of fine lines is suppressed).

From the above viewpoints, the content of strontium element is preferably 0.1% by mass or more and 1.0% by mass or less, more preferably 0.4% by mass or more and 1.0% by mass or less, still more preferably 0.5% by mass or more and 0.8% by mass or less with respect to the entire mass of the ferrite particles.

The contents of calcium element and strontium element contained in the ferrite particles are measured by fluorescent X-ray analysis. The fluorescent X-ray analysis of the ferrite particles is performed by the following method.

Qualitative and quantitative analysis is performed using an X-ray fluorescence spectrometer (XRF1500, Shimadzu Corporation) under the following conditions of X-ray output: 40 V/70 mA, measurement area: diameter 10 mm, and measurement time: 15 minutes. The element to be analyzed is selected based on the element detected by the qualitative analysis. Mainly, iron (Fe), manganese (Mn), magnesium (Mg), calcium (Ca), strontium (Sr), oxygen (O), and carbon (C) are selected. The mass proportion (%) of each element is calculated with reference to separately created calibration curve data.

The volume average particle size of the magnetic particles is preferably 20 μm or more and 50 μm or less, more preferably 25 μm or more and 45 μm or less, still more preferably 30 μm or more and 40 μm or less.

The magnetic force of the magnetic particles is such that the saturation magnetization in a magnetic field of 3000 oersteds is, for example, 50 emu/g or more, preferably 60 emu/g or more. The saturation magnetization is measured using a vibrating sample magnetometer VSMP10-15 (TOEI INDUSTRY CO., LTD.). The measurement sample is packed in a cell having an inner diameter of 7 mm and a height of 5 mm and set in the instrument. In the measurement, an applied magnetic field is applied and swept up to 3000 oersteds. Next, the applied magnetic field is decreased and a hysteresis curve is created on the recording paper. From the data of the curve, saturation magnetization, residual magnetization, and coercivity are determined.

The volume electric resistance (volume resistivity) of the magnetic particles is, for example, 1×10⁵ Ω·cm or more and 1×10⁹ Ω·cm or less, preferably 1×10⁷ Ω·cm or more and 1×10⁹ Ω·cm or less.

The volume electric resistance (Ω·cm) of the magnetic particles is measured as follows. The object to be measured is placed flat so as to have a thickness of 1 mm or more and 3 mm or less on the surface of a circular jig on which a 20 cm² electrode plate is disposed to form a layer. The 20 cm² electrode plate is placed thereon to sandwich the layer. In order to eliminate a gap between the objects to be measured, a load of 4 kg is applied onto the electrode plate disposed on the layer, and then the thickness (cm) of the layer is measured. The two electrodes above and below the layer are connected to an electrometer and a high-voltage power generator. A high voltage is applied to the two electrodes so that the electric field becomes 103.8 V/cm, and the current value (A) flowing at this time is read. As the measurement environment, the temperature is set to 20° C. and the humidity is set to 50% RH. The calculation formula of the volume electric resistance (Ω·cm) of the object to be measured is as shown in the following equation.

$$R = E \times 20 / ( I - {I}_{0} ) / L$$

In the formula, R represents the volume electric resistance (Ω·cm) of the object to be measured, E represents the applied voltage (V), I represents the current value (A), I₀ represents the current value (A) at an applied voltage of 0 V, and L represents the layer thickness (cm). The coefficient 20 represents the area (cm²) of the electrode plate.

### Properties of Carrier (1)

The volume average particle size of the carrier (1) is preferably 20 μm or more and 52 μm or less, more preferably 25 μm or more and 47 μm or less, still more preferably 30 m or more and 42 μm or less.

The volume average particle size of the carrier (1) is the particle size at which the cumulative percentage from the small size side in the volume-based particle size distribution is 50%. The particle size distribution of the carrier is measured using a laser diffraction/scattering particle size distribution measuring instrument.

In a case where the carrier contained in the developer is analyzed, examples of the method for separating the carrier from the developer include a method in which the toner is taken off from the developer by air blowing using an arbitrary mesh.

The magnetic force of the carrier (1) is such that the saturation magnetization in a magnetic field of 1000 oersteds is, for example, 40 emu/g or more, preferably 50 emu/g or more. The measurement of the saturation magnetization is performed in the same manner as the measurement of the saturation magnetization of the magnetic particles, except that sweeping is performed up to 1000 oersteds.

The volume electric resistance (25° C.) of the carrier (1) is, for example, 1×10⁷ Ω·cm or more and 1×10¹⁵ Ω·cm or less, preferably 1×10⁸ Ω·cm or more and 1×10⁴ Ω·cm or less, more preferably 1×10⁸ Ω·cm or more and 1×10¹¹ Ω·cm or less. The measurement of the volume electric resistance of the carrier is performed in the same manner as the measurement of the volume electric resistance of the magnetic particles.

The exposure proportion of the magnetic particles on the surface of the carrier (1) is preferably 2% or more and 20% or less, more preferably 3% or more and 15% or less, still more preferably 4% or more and 12% or less.

The exposure proportion of the magnetic particles on the surface of the carrier (1) is determined by the following method using X-ray photoelectron spectroscopy (XPS).

A target carrier and magnetic particles obtained by removing the resin coating layer from the target carrier are prepared. Examples of the method for removing the resin coating layer from the carrier include a method in which the resin component is dissolved with an organic solvent to remove the resin coating layer and a method in which the resin component is eliminated by performing heating at about 800° C. to remove the resin coating layer. Each of the carrier and the magnetic particles obtained by removing the resin coating layer is used as a measurement sample, Fe (atomic %) is quantified by XPS, calculation of (Fe in carrier)/(Fe in magnetic particles)×100 is performed, and the result is taken as an exposure proportion (%) of the magnetic particles.

The exposure proportion of the magnetic particles on the surface of the carrier (1) can be controlled by the amount of the resin used for forming the resin coating layer, and the exposure proportion decreases as the amount of the resin with respect to the amount of the magnetic particles increases.

### Carrier (2)

The carrier (2) includes magnetic particles and a resin coating layer that covers the magnetic particles.

The carrier (2) is preferably a carrier having the same configuration as that of the carrier (1) except that inorganic particles are not contained in the resin coating layer.

Examples of the magnetic particles constituting the carrier (2) include magnetic particles the same as the magnetic particles constituting the carrier (1), and the specific form and preferred form of the magnetic particles are also the same.

Examples of the resin coating layer constituting the carrier (2) include a resin coating layer the same as the resin coating layer constituting the carrier (1), and the specific form and preferred form of the resin coating layer are also the same.

Examples of the method for forming the resin coating layer in the carrier (2) include a production method the same as the method for forming the resin coating layer in the carrier (1) except that inorganic particles are not used.

### Value of B(2)−A(2)

It is preferable that the value of B(2)−A(2) in the carrier (2) is 0.3 atm % or less, where when the element ratio of the metals and semimetals that constitute the inorganic particles contained in the resin coating layer of the carrier (1) is analyzed in the depth direction by X-ray photoelectron spectroscopy, the element ratio at an etching time of 0 seconds is denoted as A(2) and the element ratio at an etching time of 300 seconds is denoted as B(2).

In the present disclosure, the “inorganic particles” of the “metals and semimetals that constitute the inorganic particles”, which are the analysis targets of the X-ray photoelectron spectroscopy according to the carrier, are the inorganic particles contained in the resin coating layer of the carrier (1). In the carrier (2) as well, the element ratio of the metals and semimetals that constitute the inorganic particles contained in the resin coating layer of the carrier (1) is analyzed.

In a case where the carrier (2) does not contain inorganic particles in the resin coating layer, the A(2) value and B(2) value derived from the carrier (2) itself are zero, but the inorganic particles (for example, silica particles, alumina particles, and titania particles), which are an external additive of the toner (2), are attached to the surface of the carrier (2) or are embedded in the resin coating layer of the carrier (2) in some cases, and thus the A(2) value and the B(2) value are not zero in some cases.

The value of B(2)−A(2) is more preferably 0.3 atm % or less, still more preferably 0.2 atm % or less from the viewpoint of suppressing the occurrence of filming on the surface of the image holding member located downstream in a tandem-type image forming apparatus.

The element analysis in the depth direction by XPS and the measurement method of the element ratio A(2) and element ratio B(2) in the carrier (2) are the same as the element analysis in the depth direction by XPS and the measurement method of the element ratio A(1) and element ratio B(1) in the carrier (1).

The resin coating layer of the carrier (2) preferably contains a nitrogen atom-containing resin. Examples of the nitrogen atom-containing resin include a binder resin and/or resin particles.

The nitrogen atom-containing binder resin is preferably an acrylic resin having a constitutional unit having an amino group, and the (meth)acrylic monomer having an amino group is preferably a dialkylaminoalkyl (meth)acrylate, more preferably dimethylaminoethyl (meth)acrylate.

The nitrogen atom-containing resin particles are preferably amino resin particles, more preferably melamine resin particles.

When the mass proportion of the nitrogen atom-containing resin to the entire mass of the resin coating layer of the carrier (2) is denoted as R(2), the value of R(2) is preferably 5% by mass or more and 20% by mass or less, more preferably 7% by mass or more and 18% by mass or less, still more preferably 10% by mass or more and 16% by mass or less.

The value of the ratio R(1)/R(2) of R(1) of the carrier (1) to R(2) of the carrier (2) is preferably 0.2 or more and 4.0 or less, more preferably 0.4 or more and 3.0 or less, still more preferably 1.0 or more and 1.7 or less from the viewpoint of suppressing the occurrence of filming on the surface of the image holding member located downstream in a tandem-type image forming apparatus.

The degrees of the volume average particle size, magnetic force, volume electric resistance, and exposure proportion of the magnetic particles of the carrier (2) are the same as those of the carrier (1), and preferred numerical ranges thereof are also the same.

### Toner (1) and Toner (2)

The toner (1) and the toner (2) are preferably toners having the same configuration except that the colors are different from each other. Hereinafter, the toner (1) and the toner (2) will be collectively referred to as “toner” and described.

The toner is not particularly limited, and a known toner is used. Examples thereof include a colored toner including toner particles containing a binder resin and a colorant, and also include an infrared absorbing toner using an infrared absorber instead of a colorant is also exemplified. The toner may contain a release agent, various internal additives and external additives, and the like.

### Toner Particles

### Binder Resin

Examples of the binder resin include vinyl resins composed of homopolymers of monomers such as styrenes (for example, styrene, para-chlorostyrene, and α-methylstyrene), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers obtained by combining two or more of these monomers.

Examples of the binder resin also include non-vinyl resins such as an epoxy resin, a polyester resin, a polyurethane resin, a polyamide resin, a cellulose resin, a polyether resin, and a modified rosin, mixtures of these and the vinyl resins, and graft polymers obtained by polymerizing vinyl monomers in the presence of these.

These binder resins may be used singly or in combination of two or more kinds thereof.

The binder resin is preferably a polyester resin, a styrene-acrylic resin, or a styrene-acryl-modified polyester resin, more preferably a polyester resin.

The glass transition temperature (Tg) of the resin is preferably 50° C. or more and 80° C. or less, more preferably 50° C. or more and 65° C. or less.

The glass transition temperature is determined from a DSC curve acquired by differential scanning calorimetry (DSC), and more specifically, is determined by the “extrapolated glass transition starting temperature” described in the method for determining a glass transition temperature in JIS K 7121-1987 “Testing methods for transition temperatures of plastics”.

The weight average molecular weight (Mw) of the resin is preferably 5000 or more and 1,000,000 or less, more preferably 7000 or more and 500000 or less. The number average molecular weight (Mn) of the resin is preferably 2000 or more and 100000 or less. The molecular weight distribution Mw/Mn of the resin is preferably 1.5 or more and 100 or less, more preferably 2 or more and 60 or less.

The weight average molecular weight and the number average molecular weight are measured by gel permeation chromatography (GPC). The molecular weight measurement by GPC is performed using a THE solvent, GPC HLC-8120GPC (Tosoh Corporation) as a measuring instrument, and TSKgel SuperHM-M (diameter: 15 cm, Tosoh Corporation) as a column. The weight average molecular weight and the number average molecular weight are calculated from the measurement results using a molecular weight calibration curve created with monodisperse polystyrene standard samples.

The content of the binder resin is preferably 40% by mass or more and 95% by mass or less, more preferably 50% by mass or more and 90% by mass or less, still more preferably 60% by mass or more and 85% by mass or less with respect to the entire amount of the toner particles.

### Colorant

Examples of the colorant include pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchyoung Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and dyes such as acridine-based, xanthene-based, azo-based, benzoquinone-based, azine-based, anthraquinone-based, thioindigo-based, dioxazine-based, thiazine-based, azomethine-based, indigo-based, phthalocyanine-based, aniline black-based, polymethine-based, triphenylmethane-based, diphenylmethane-based, and thiazole-based dyes.

The colorants may be used singly or in combination of two or more kinds thereof.

As the colorant, a surface-treated colorant may be used if necessary, or the colorant may be used in combination with a dispersant. A plurality of colorants may be used in combination.

The content of the colorant is preferably 1% by mass or more and 30% by mass or less, more preferably 3% by mass or more and 15% by mass or less with respect to the entire amount of the toner particles.

### Release Agent

Examples of the release agent include hydrocarbon-based waxes; natural waxes such as carnauba wax, rice wax, and candelilla wax; synthetic or mineral/petroleum-based waxes such as montan wax; and ester-based waxes such as fatty acid esters and montanic acid esters. The release agent is not limited thereto.

The melting temperature of the release agent is preferably 50° C. or more and 110° C. or less, more preferably 60° C. or more and 100° C. or less.

The melting temperature is determined from a DSC curve acquired by differential scanning calorimetry (DSC) by the “melting peak temperature” described in a method for determining a melting temperature in JIS K 7121-1987 “Testing methods for transition temperatures of plastics”.

The content of the release agent is preferably 1% by mass or more and 20% by mass or less, more preferably 5% by mass or more and 15% by mass or less with respect to the entire amount of the toner particles.

### Other Additives

Examples of other additives include known additives such as a magnetic material, a charge control agent, and an inorganic powder. These additives are contained in the toner particles as an internal additive.

### Properties of Toner Particles

The toner particles may be toner particles having a single layer structure or toner particles having a so-called core-shell structure including a core (core particle) and a coating layer (shell layer) coating the core. The toner particles having a core-shell structure preferably include, for example, a core containing a binder resin and, if necessary, other additives such as a colorant and a release agent, and a coating layer containing a binder resin.

The volume average particle size (D50v) of the toner particles is preferably 2 μm or more and 10 μm or less, more preferably 4 μm or more and 8 μm or less.

The volume average particle size (D50v) of the toner particles is measured using Coulter Multisizer II (Beckman Coulter, Inc.) and ISOTON-II (Beckman Coulter, Inc.) as an electrolytic solution. In the measurement, 0.5 mg or more and 50 mg or less of a measurement sample is added to 2 ml of a 5% by mass aqueous solution of a surfactant (preferably sodium alkylbenzene sulfonate) as a dispersant. This is added to 100 ml or more and 150 ml or less of the electrolytic solution. The electrolytic solution in which the sample is suspended is subjected to dispersion treatment for 1 minute using an ultrasonic disperser, and the particle size distribution of particles having a particle size in a range of 2 μm or more and 60 μm or less is measured using Coulter Multisizer II and an aperture having an aperture diameter of 100 μm. The number of particles to be sampled is 50,000.

### External Additive

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO SiO₂, K₂O·(TiO₂)ₙ, Al₂O₃·2SiO₂, CaCO₃, MgCO₃, BaSO₄, MgSO₄, and SrTiO₃.

The surfaces of the inorganic particles as an external additive may be subjected to hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. These may be used singly or in combination of two or more kinds thereof.

The amount of the hydrophobizing agent is, for example, preferably 1 part by mass or more and 30 parts by mass or less with respect to 100 parts by mass of the inorganic particles.

Examples of the external additives also include resin particles (resin particles of polystyrene, polymethyl methacrylate, and melamine resin) and cleaning activators (for example, metal salts of higher fatty acids represented by zinc stearate, and particles of fluorine-based high molecular weight compounds).

The amount of the external additives externally added is preferably 0.01% by mass or more and 10% by mass or less, more preferably 0.01% by mass or more and 5% by mass or less with respect to the amount of the toner particles.

### Method for Producing Toner

The toner is obtained by producing toner particles and then externally adding an external additive to the toner particles. The toner particles may be produced by any of a dry process (for example, a kneading and pulverization process) or a wet process (for example, an aggregation and coalescence process, a suspension and polymerization process, or a dissolution and suspension process). These production processes are not particularly limited, and known production processes are adopted. Among these, the toner particles may be obtained by the aggregation and coalescence process.

### Image Forming Apparatus and Image Forming Method

The developer set of the present disclosure is applied to a tandem-type image forming apparatus.

The tandem-type image forming apparatus includes two or more image forming units. Examples of the tandem-type image forming apparatus include the following modes (1) and (2).

In the following description, yellow is expressed as “Y”, magenta is expressed as “M”, cyan is expressed as “C”, black is expressed as “K”, and special colors (for example, white, green, orange, pink, gold, and silver) are expressed as “S”.
Mode (1): 4-Series tandem-type image forming apparatus in which YMCK are arranged in order from upstream side

Y is the developer (1), and K is the developer (2). It is preferable that both M and C are the developer (1).
Mode (2): 5-Series or more tandem-type image forming apparatus in which YMCK are arranged in order from upstream side and at least one S is further arranged on upstream side and/or downstream side of YMCK

Y is the developer (1), and K is the developer (2). It is preferable that both M and C are the developer (1).

S may be any of the developer (1) or the developer (2) since S is less frequently used, but S is preferably the developer (1) in a case where S is on the upstream side of YMCK and S is preferably the developer (2) in a case where S is on the downstream side of YMCK.

Representative examples of the exemplary embodiment of the image forming apparatus according to the present exemplary embodiment include the following.

An image forming apparatus including: a first image forming unit configured to form a yellow image;
a second image forming unit configured to form a magenta image;
a third image forming unit configured to form a cyan image; and
a fourth image forming unit configured to form a black image, in which
the image forming apparatus contains the developer set of the present disclosure,
a developer (1) is accommodated a developing device of each of the first image forming unit, the second image forming unit, and the third image forming unit, and
a developer (2) is accommodated a developing device of the fourth image forming unit.

In the exemplary embodiment, the developers (1) contained in the respective developing devices of the first image forming unit, the second image forming unit, and the third image forming unit are developers (1) that are different in color from one another.

Representative examples of the exemplary embodiment of the image forming method according to the present exemplary embodiment include the following.

An image forming method including: a first image forming step of forming a yellow image;
a second image forming step of forming a magenta image;
a third image forming step of forming a cyan image; and
a fourth image forming step of forming a black image, in which
the developer set of the present disclosure is used,
a developer (1) is used in a developing step of each of the first image forming step, the second image forming step, and the third image forming step, and
a developer (2) is used in a developing step of the fourth image forming step.

In the exemplary embodiment, the developers (1) used in the respective developing steps of the first image forming step, the second image forming step, and the third image forming step are developers (1) that are different in color from one another.

Hereinafter, an example of the image forming apparatus according to the present exemplary embodiment will be described, but the image forming apparatus is not limited thereto. In the following description, main parts illustrated in the drawing will be described, and description of the other parts will be omitted.

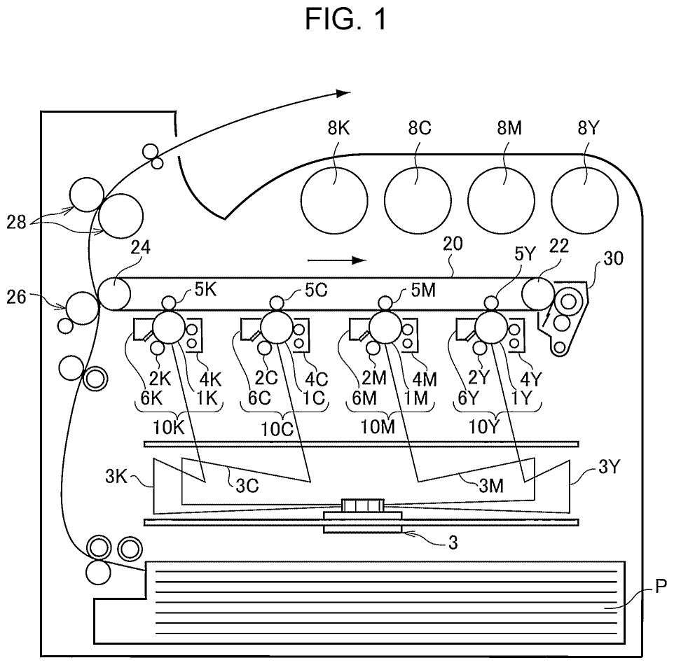

FIG. 1 is a schematic configuration diagram illustrating the image forming apparatus according to the present exemplary embodiment, and is a diagram illustrating an image forming apparatus of a 4-series tandem type and an intermediate transfer type.

The image forming apparatus illustrated in FIG. 1 includes first to fourth electrophotographic image forming units 10Y, 10M, 10C, and 10K that output images of yellow (Y), magenta (M), cyan (C), and black (K), respectively, based on the color-separated image data. These image forming units (hereinafter simply referred to as “units” in some cases) 10Y, 10M, 10C, and 10K are horizontally disposed side by side at predetermined intervals. These units 10Y, 10M, 10C, and 10K may be process cartridges detachably attached to the image forming apparatus.

Above the respective units 10Y, 10M, 10C, and 10K, an intermediate transfer belt (an example of the intermediate transfer member) 20 extends through the respective units. The intermediate transfer belt 20 is provided to be wound around a driving roller 22 and a supporting roller 24 so as to run in the direction from the first unit 10Y toward the fourth unit 10K. Force is applied to the supporting roller 24 in the direction away from the driving roller 22 by a spring or the like (not illustrated), and tension is applied to the intermediate transfer belt 20 that is wound around the supporting roller 24 and the driving roller 22. An intermediate transfer member cleaning device 30 is provided on the outer peripheral surface of the intermediate transfer belt 20 so as to face the driving roller 22.

The toners of yellow, magenta, cyan, and black accommodated in the toner cartridges 8Y, 8M, 8C, and 8K are respectively supplied to the developing devices (an example of the developing device) 4Y, 4M, 4C, and 4K of the respective units 10Y, 10M, 10C, and 10K.

Since the first to fourth units 10Y, 10M, 10C, and 10K have the same configuration and operation, the first unit 10Y that is disposed on the upstream side in the intermediate transfer belt running direction and forms a yellow image will be described here as a representative.

The first unit 10Y includes a photoreceptor 1Y acting as an image holding member. Around the photoreceptor 1Y, a charging roller (an example of the charging device) 2Y that charges the surface of the photoreceptor 1Y to a predetermined potential, an exposure device (an example of the electrostatic charge image forming device) 3 that forms an electrostatic charge image by exposing the charged surface to a laser beam 3Y based on a color-separated image signal, a developing device (an example of the developing device) 4Y that develops the electrostatic charge image by supplying a charged toner to the electrostatic charge image, a primary transfer roller (an example of the primary transfer device) 5Y that transfers the developed toner image onto the intermediate transfer belt 20, and a photoreceptor cleaning device (an example of the cleaning device) 6Y that removes toner remaining on the surface of the photoreceptor 1Y after the primary transfer are disposed in the order.

The first transfer roller 5Y is disposed inside the intermediate transfer belt 20 and is provided at a position facing the photoreceptor 1Y. A bias power source (not illustrated) that applies a primary transfer bias is connected to each of the primary transfer rollers 5Y, 5M, 5C, and 5K of the respective units. Each bias power source changes the value of the transfer bias applied to each primary transfer roller through control by a control section (not illustrated).

Hereinafter, an operation of forming a yellow image in the first unit 10Y will be described.

First, prior to the operation, the surface of the photoreceptor 1Y is charged to a potential of −600 V to −800 V by the charging roller 2Y.

The photoreceptor 1Y is formed by stacking a photosensitive layer on an electrically conductive (for example, a volume resistivity of 1×10⁻⁶ Ω·cm or less at 20° C.) substrate. The photosensitive layer usually has a high resistance (resistance of a general resin), but has a property that the specific resistance of a portion irradiated with a laser beam changes when the portion is irradiated with the laser beam. Then, the surface of the charged photoreceptor 1Y is irradiated with the laser beam 3Y from the exposure device 3 in accordance with the yellow image date sent from the control section (not illustrated). Thus, an electrostatic charge image of a yellow image pattern is formed on the surface of the photoreceptor 1Y

The electrostatic charge image is an image formed on the surface of the photoreceptor 1Y by charging, and is a so-called negative latent image formed by the fact that the specific resistance of the irradiated portion of the photosensitive layer is decreased by the laser beam 3Y, the charges on the surface of the photoreceptor 1Y flow, and the charges at the portions not irradiated with the laser beam 3Y remain.

The electrostatic charge image formed on the photoreceptor 1Y rotates to a predetermined developing position as the photoreceptor 1Y runs. Next, at the developing position, the electrostatic charge image on the photoreceptor 1Y is developed into a toner image by the developing device 4Y to be visualized.

In the developing device 4Y, for example, an electrostatic charge image developer containing at least a yellow toner and a carrier is accommodated. The yellow toner is triboelectrically charged by being stirred inside the developing device 4Y, has a charge of the same polarity (negative polarity) as the charge on the photoreceptor 1Y, and is held on a developer roller (an example of the developer holding member). Next, as the surface of the photoreceptor 1Y passes through the developing device 4Y, the yellow toner electrostatically adheres to the charge-erased latent image portion on the surface of the photoreceptor 1Y, and the latent image is developed with the yellow toner. The photoreceptor 1Y on which the yellow toner image has been formed is continuously run at a predetermined speed, and the toner image developed on the photoreceptor 1Y is conveyed to a predetermined primary transfer position.

When the yellow toner image on the photoreceptor 1Y is conveyed to the primary transfer position, a primary transfer bias is applied to the primary transfer roller 5Y, the electrostatic force directed from the photoreceptor 1Y to the primary transfer roller 5Y acts on the toner image, and the toner image on the photoreceptor 1Y is transferred onto the intermediate transfer belt 20. The transfer bias applied at this time has a (+) polarity opposite to the (−) polarity of the toner, and is controlled to, for example, +10 μA by the control section (not illustrated) in the first unit 10Y

Meanwhile, toner remaining on the photoreceptor 1Y is removed and collected by the photoreceptor cleaning device 6Y.

The primary transfer bias applied to the primary transfer rollers 5M, 5C, and 5K of the second unit 10M and subsequent units is also controlled in the same manner as the first unit.

In this way, the intermediate transfer belt 20 on which the yellow toner image is transferred in the first unit 10Y is sequentially conveyed through the second to fourth units 10M, 10C, and 10K, and the toner images of the respective colors are superimposed and transferred in a superimposed manner.

The intermediate transfer belt 20 on which the toner images of four colors have been transferred in a superimposed manner while passing through the first to fourth units reaches a secondary transfer portion constituted of the intermediate transfer belt 20, the supporting roller 24 in contact with the inner surface of the intermediate transfer belt, and a secondary transfer roller (an example of the secondary transfer device) 26 disposed on the outer peripheral surface side of the intermediate transfer belt 20. Meanwhile, a recording sheet (an example of the recording medium) P is fed to the gap between the secondary transfer roller 26 and the intermediate transfer belt 20 in contact with each other at predetermined timing via a supply mechanism, and a secondary transfer bias is applied to the supporting roller 24. The transfer bias applied at this time has the same (−) polarity as the (−) polarity of the toner, and the electrostatic force directed from the intermediate transfer belt 20 toward the recording sheet P acts on the toner image, and the toner image on the intermediate transfer belt 20 is transferred onto the recording sheet P. The secondary transfer bias at this time is determined in accordance with the resistance detected by resistance detecting device (not illustrated) that detects the resistance of the secondary transfer portion, and is voltage-controlled.

Thereafter, the recording sheet P is fed into a pressure-contact portion (nip portion) between a pair of fixing rollers in a fixing device (an example of the fixing device) 28, and the toner image is fixed onto the recording sheet P, thereby forming a fixed image.

Examples of the recording sheet P onto which the toner image is transferred include plain paper used in electrophotographic copying machines, printers, and the like. Examples of the recording medium include an OHP sheet in addition to the recording sheet P.

In order to further improve the smoothness of the image surface after fixing, the surface of the recording sheet P is also preferably smooth, and for example, coated paper obtained by coating the surface of plain paper with a resin or the like, art paper for printing, and the like are suitably used.

The recording sheet P on which the color image has been fixed is carried out toward a discharge section, and a series of color image forming operations is finished.

### EXAMPLES

Hereinafter, the present exemplary embodiments will be described in detail with reference to Examples, but the present exemplary embodiments are not limited to these Examples at all. In the following description, unless otherwise particularly stated, “parts” and “%” are based on mass.

In the following description, synthesis, treatment, production, test and the like are performed at room temperature (25° C.±3° C.) unless otherwise stated.

### Production of Black Toner

### Preparation of Resin Particle Dispersion (1)

Ethylene glycol: 37 parts
Neopentyl glycol: 65 parts
1,9-Nonanediol: 32 parts
Terephthalic acid: 96 parts

A flask is charged with the materials, the temperature is raised to 200° C. over 1 hour, it is found that the inside of the reaction system is uniformly stirred, and then 1.2 parts of dibutyltin oxide is put. While the generated water is distilled off, the temperature is raised to 240° C. over 6 hours, and stirring is continuously performed at 240° C. for 4 hours to obtain a polyester resin (acid value: 9.4 mgKOH/g, weight average molecular weight: 13,000, glass transition temperature: 62° C.). This polyester resin is transported in a molten state to an emulsifying and dispersing machine (CAVITRON CD1010, EUROTEC CO., LTD.) at a rate of 100 g per minute. Separately, diluted ammonia water, which is prepared by diluting reagent ammonia water with ion-exchanged water and has a concentration of 0.37%, is put into a tank and transported to the emulsifying and dispersing machine at a rate of 0.1 L per minute together with the polyester resin while being heated to 120° C. using a heat exchanger. The emulsifying and dispersing machine is operated under the conditions of a rotor rotational speed of 60 Hz and a pressure of 5 kg/cm² to obtain a resin particle dispersion (1) having a volume average particle size of 160 nm and a solid content of 30%.

### Preparation of Resin Particle Dispersion (2)

Decanedioic acid: 81 parts
Hexanediol: 47 parts

A flask is charged with the materials, the temperature is raised to 160° C. over 1 hour, it is found that the inside of the reaction system is uniformly stirred, and then 0.03 parts of dibutyltin oxide is put. While the generated water is distilled off, the temperature is raised to 200° C. over 6 hours, and stirring is continuously performed at 200° C. for 4 hours. Next, the reaction mixture is cooled, solid-liquid separation is performed, and the solid is dried at a temperature of 40° C. under reduced pressure to obtain a polyester resin (C1) (melting point: 64° C., weight average molecular weight: 15,000).
Polyester resin (C1): 50 parts
Anionic surfactant (NEOGEN SC, DKS Co., Ltd.): 2 parts
Ion-exchanged water: 200 parts

The materials are heated to 120° C., thoroughly dispersed using a homogenizer (ULTRA-TURRAX T50, IKA), and then dispersed using a pressure-discharge homogenizer. When the volume average particle size reached 180 nm, collection is performed to obtain a resin particle dispersion (2) having a solid content of 20%.

### Preparation of Colorant Particle Dispersion (1)

Black pigment (Regel330, Cabot Corporation): 10 parts
Anionic surfactant (NEOGEN SC, DKS Co., Ltd.): 2 parts
Ion-exchanged water: 80 parts

The materials are mixed and dispersed for 1 hour using a high-pressure impact disperser (ULTIMIZER HJP30006, SUGINO MACHINE LIMITED) to obtain a colorant particle dispersion (1) having a volume average particle size of 180 nm and a solid content of 20%.

### Preparation of Release Agent Particle Dispersion (1)

Paraffin wax (HNP-9, NIPPON SEIRO CO., LTD.): 50 parts
Anionic surfactant (NEOGEN SC, DKS Co., Ltd.): 2 parts
Ion-exchanged water: 200 parts

The materials are heated to 120° C., thoroughly dispersed using a homogenizer (ULTRA-TURRAX T50, IKA), and then dispersed using a pressure-discharge homogenizer. When the volume average particle size reached 200 nm, collection is performed to obtain a release agent particle dispersion (1) having a solid content of 20%.

### Preparation of Toner (K)

Resin particle dispersion (1): 150 parts
Resin particle dispersion (2): 50 parts
Colorant particle dispersion (1): 25 parts
Release agent particle dispersion (1): 35 parts
Polyaluminum chloride: 0.4 parts
Ion-exchanged water: 100 parts

The materials are put in a round stainless steel flask, thoroughly mixed and dispersed using a homogenizer (ULTRA-TURRAX T50, IKA), and then heated to 48° C. in a heating oil bath while the inside of the flask is stirred. The inside of the reaction system is maintained at 48° C. for 60 minutes, and then, 70 parts of the resin particle dispersion (1) is gradually added. Next, the pH is adjusted to 8.0 using a 0.5 mol/L aqueous sodium hydroxide solution, the flask is sealed, the seal of the stirring shaft is magnetically sealed, and the mixture is heated to 90° C. and maintained at that temperature for 30 minutes while stirring is continuously performed. Next, cooling is performed at a temperature decrease rate of 5° C./min, solid-liquid separation is performed, and washing with ion-exchanged water is sufficiently performed. Next, solid-liquid separation is performed, and the solid is redispersed in ion-exchanged water at a temperature of 30° C., stirred at a rotational speed of 300 rpm (revolutions per minute) for 15 minutes, and washed. This washing operation is further repeated 6 times, solid-liquid separation is performed when the pH of the filtrate became 7.54 and the electric conductivity became 6.5 S/cm, and vacuum drying is continuously performed for 24 hours to obtain toner particles (K) having a volume average particle size of 5.7 μm.

A toner (K) is obtained by mixing 100 parts of the toner particles (K) and 2.5 parts of silica particles (surface hydrophobized with hexamethyldisilazane, average primary particle size: 40 nm) using a Henschel mixer.

### Production of Yellow Toner

A toner (Y) is produced in the same manner as in the production of the black toner except that the black pigment is changed to a yellow pigment (C.I. Pigment Yellow 74, Clariant Japan K.K.) in the preparation of the colorant particle dispersion.

### Production of Magenta Toner

A toner (M) is produced in the same manner as in the production of the black toner except that the black pigment is changed to a magenta pigment (C.I. Pigment Red 122, DIC Corporation) in the preparation of the colorant particle dispersion.

### Production of Cyan Toner

A toner (C) is produced in the same manner as in the production of the black toner except that the black pigment is changed to a cyan pigment (C.I. Pigment Blue 15:3, Dainichiseika Color & Chemicals Mfg. Co., Ltd.) in the preparation of the colorant particle dispersion.

### Production of Carrier (1)

### Production of Ferrite Particles (1)

Fe₂O₃: 1597 parts
Mn(OH)₂: 712 parts
Mg(OH)₂: 116 parts
SrCO₃: 20 parts
CaCO₃: 30 parts

The materials are mixed, a dispersant, water, and zirconia beads having a diameter of 1 mm are added, and the mixture is crushed and mixed using a sand mill. The zirconia beads are separated by filtration, and the filtrate is dried and then calcined using a rotary kiln under the conditions of a rotational speed of 20 rpm/a temperature of 970° C./2 hours. A dispersant and water are added to the obtained calcined product, 8 parts of polyvinyl alcohol is further added, and pulverization and mixing are performed for 5 hours using a wet ball mill. The volume average particle size of the pulverized product thus obtained is 1.2 km. Next, the pulverized product is granulated using a spray dryer so as to have a particle size of 40 μm. The granulated product thus obtained is fired in an electric furnace in an oxygen-nitrogen mixed atmosphere having an oxygen concentration of 1% by volume under the conditions of a temperature of 1400° C./4 hours. The fired product thus obtained is crushed and classified to obtain ferrite particles (1). The volume average particle size of the ferrite particles (1) is 35 μm.

### Preparation of Coating Agent for First Layer and Coating Agent for Second Layer

In the present Example, the value of B(1)−A(1) is controlled by a method for forming the resin coating layer in a plurality of steps. The present Example is an example of the method for controlling the value of B(1)−A(1), and the method for controlling the value of B(1)−A(1) is not limited thereto.

The respective components presented in Tables 1-1 and 1-2 at the mass ratios presented in Table 1-1 and glass beads (diameter: 1 mm, the same amount as that of toluene) are put in a sand mill and stirred at a rotational speed of 190 rpm for 30 minutes to prepare a coating agent for first layer and a coating agent for second layer, respectively.

The details of the abbreviations of the respective components for the coating agents presented in Tables 1-1 and 1-2 are as follows.
Resin (1): Cyclohexyl methacrylate/2-(dimethylamino)ethyl methacrylate copolymer (copolymerization ratio 97 mol:3 mol)
Resin (2): Cyclohexyl methacrylate/methyl methacrylate copolymer (copolymerization ratio 95 mol:5 mol)
Resin (3): Methyl methacrylate polymer
Resin (4): Cyclohexyl methacrylate/2-(dimethylamino)ethyl methacrylate copolymer (copolymerization ratio 99.5 mol:0.5 mol)
Surface-treated silica (S1): Silica particles (HM20S, Tokuyama Corporation, average primary particle size: 12 nm, surface treatment agent: hexamethyldisilazane)
Surface-treated silica (S2): Silica particles (NX90S, Nippon Aerosil Co., Ltd., average primary particle size: 22 nm, surface treatment agent: hexamethyldisilazane)
Surface-treated silica (S3): Silica particles (RY200, Nippon Aerosil Co., Ltd., average primary particle size: 12 nm, surface treatment agent: silicone oil)
Surface-treated silica (S4): Silica particles (HM30S, Tokuyama Corporation, average primary particle size: 7 nm, surface treatment agent: hexamethyldisilazane)
Surface-treated silica (S5): Silica particles (average primary particle size: 30 nm, dry silica, surface treatment agent: hexamethyldisilazane)
Surface-treated silica (S6): Silica particles (average primary particle size: 40 nm, dry silica, surface treatment agent: hexamethyldisilazane)
Surface-treated silica (S7): Silica particles (RX50, Nippon Aerosil Co., Ltd., average primary particle size: 65 nm, surface treatment agent: hexamethyldisilazane)
Surface-untreated silica (Sn): Silica particles (QS-20, Tokuyama Corporation, average primary particle size: 12 nm)
Surface-treated alumina (A): Alumina particles (AluC805, Nippon Aerosil Co., Ltd., average primary particle size: 22 nm, surface treatment agent: octylsilane)
Surface-treated titania (T): Titania particles (T805, Nippon Aerosil Co., Ltd., average primary particle size: 20 nm, surface treatment agent: octylsilane)
Resin particles (M1): Melamine resin particles (EPOSTAR FS, NIPPON SHOKUBAI CO., LTD., average primary particle size: 250 nm)
Resin particles (M4): Melamine resin particles (EPOSTAR S6, NIPPON SHOKUBAI CO., LTD., average primary particle size: 400 nm)
Resin particles (A1): Acrylic resin particles (MP-1441, Soken Chemical & Engineering Co., Ltd., average primary particle size: 150 nm)
Resin particles (A2): Acrylic resin particles (MP-2200, Soken Chemical & Engineering Co., Ltd., average primary particle size: 350 nm)
CB: Carbon black (VXC72, Cabot Corporation)

### Production of Carrier—Part 1—

Using SPIRA COTA (OKADA SEIKO CO., LTD.), the coating agent for first layer is applied to the surfaces of 1,000 parts of the ferrite particles (1) in an atmosphere at 70° C. at a rate of 30 g/min so that the components of the resin coating layer are 15 parts with respect to the ferrite core material. Next, the coating agent for second layer is applied at a rate of 30 g/min so that the components of the resin coating layer is 15 parts with respect to the ferrite particles (1), and then drying is performed. The dried powder is taken out from SPIRA COTA, and crushed using a sieve having an opening of 75 μm to obtain each of carriers (1-1) to (1-36) and carriers (1-C1) to (1-C2).

### Measurement of Volume Average Particle Size of Carrier

Using the carriers as a sample, the particle size of the carriers is measured using a laser diffraction/scattering particle size distribution measuring instrument (LS Particle Size Analyzer: LS13 320, Beckman Coulter, Inc.). The particle size (μm) at which the cumulative percentage from the small size side in the volume-based particle size distribution is 50% is determined.

The volume average particle size of each of the carriers (1-1) to (1-36) and carriers (1-C1) to (1-C2) is 36 μm.

### Elemental Analysis by XPS

Using the carriers as a sample, and carbon, nitrogen, oxygen, iron, manganese, and metals and semimetals constituting the inorganic particles are analyzed by XPS using an etching method.

In a case where the inorganic particles are silica particles, carbon, nitrogen, oxygen, iron, manganese, and silicon are analyzed.

In a case where the inorganic particles are alumina particles, carbon, nitrogen, oxygen, iron, manganese, and aluminum are analyzed.

In a case where the inorganic particles are titania particles, carbon, nitrogen, oxygen, iron, manganese, and titanium are analyzed.

The element ratio (atm %) of the metals and semimetals that constitute the inorganic particles in the total element amount of all the elements, which are the analysis targets, is determined. The element ratio at the etching time of 0 seconds is A (atm %), and the element ratio at an etching time of 300 seconds is B (atm %).

The XPS is performed using the following instrument under the following conditions. The analysis is performed after baseline correction.
XPS instrument: PHI5000 Versa ProbeII (ULVAC-PHI, INCORPORATED)
X-ray source: Monochromatized AlKα rays
Beam voltage: 15 kV
Emission current: 3 mA
Etching gun: Argon gas cluster ion gun
Vacuum degree: 1×10⁻⁵ Pa to 1×10⁻⁶ Pa
Pass Energy: 23.5 eV
Sweep region: 300 m×300 m
Time Per Step: 50 seconds
Cycle: 5 cycles
Sweep: 10 times

### Production of Carrier (2)

The respective components presented in Table 2 at the mass ratio presented in Table 2 and glass beads (diameter: 1 mm, the same amount as that of toluene) are put in a sand mill and stirred at a rotational speed of 190 rpm for 30 minutes to prepare each coating agent.

In a kneader, 1,000 parts of the ferrite particles (1) and 125 parts of the coating agent are put and mixed at room temperature (25° C.) for 20 minutes. The mixture is then heated to 70° C. and dried under reduced pressure.

The dried product is cooled to room temperature (25° C.), 125 parts of the coating agent is further added, and mixing is performed at room temperature (25° C.) for 20 minutes. The mixture is then heated to 70° C. and dried under reduced pressure.

Next, the dried product is taken out from the kneader and sieved through a mesh having an opening of 75 μm to remove coarse powder, thereby producing carriers (2-1) to (2-8).

The composition of the coating agent is as presented in Table 2. The details of the abbreviations of the respective components for the coating agents are as described above.

Using the carriers as a sample, the particle size of the carriers is measured using a laser diffraction/scattering particle size distribution measuring instrument (LS Particle Size Analyzer: LS13 320, Beckman Coulter, Inc.). The particle size (m) at which the cumulative percentage from the small size side in the volume-based particle size distribution is 50% is determined.

The volume average particle size of each of the carriers (2-1) to (2-8) is 36 μm. Production of developer (Y), developer (M), and developer (C)

The toner (Y), the toner (M), and the toner (C) are combined with one among the carriers (1-1) to (1-36) and the carriers (1-C1) to (1-C2) to produce a yellow developer (Y), a magenta developer (M), and a cyan developer (C).

In a V-blender, 100 parts of the carrier and 6 parts of the toner are put and stirred for 20 minutes. Thereafter, the mixture is sieved through a sieve having an opening of 212 μm to obtain a developer.

### Production of Developer (K)

The toner (K) and one among the carriers (2-1) to (2-8) are combined to produce a black developer (K).

In a V-blender, 100 parts of the carrier and 6 parts of the toner are put and stirred for 20 minutes. Thereafter, the mixture is sieved through a sieve having an opening of 212 μm to obtain a developer.

### Performance Evaluation

### Black Photoreceptor Filming

A modified machine of Color 1000 Press (Fujifilm Business Innovation Corp.), which is a 4-series tandem type image forming apparatus, is prepared. Four colors are arranged in the order of YMCK from the upstream side. The developer of each color is accommodated in the developing device of each color. In the image forming unit of each color, the contact angle θ between the photoreceptor (an example of the image holding member) and the photoreceptor cleaning blade is set to 11°, and the pressing pressure N of the photoreceptor cleaning blade against the photoreceptor is set to 2.5 gf/mm².

In an environment at a temperature of 28° C. and a relative humidity of 85%, an image in which the average image density of each of YMCK is 5% is formed on 10,000 sheets of A4 plain paper. Next, in an environment at a temperature of 10° C. and a relative humidity of 15%, an image in which the average image density of each of YMCK is 5% is formed on 1,000 sheets of A4 plain paper. After the printing cycle is performed two times, an image in which the average image density of each of YMCK is 40% is formed on 10,000 sheets of A4 plain paper in an environment at a temperature of 10° C. and a relative humidity of 15%. Thereafter, the surfaces of the black photoreceptors (the most downstream photoreceptors) are analyzed using a laser microscope, and the area proportions of filming in a visual field of 300 m×250 m are classified as follows. The results are presented in Table 3.
A: less than 5%
B+: 5% or more and less than 15%
B: 15% or more and less than 25%
B−: 25% or more and less than 35%
C: 35% or more and less than 50%
C−: 50% or more and less than 60%
D: 60% or more and less than 75%
E: 75% or more

TABLE 1-1

| | | Composition of coating agent | | | | | | | Composition of coating agent | | | | | | |
|---|---|---|---|---|---|---|---|---|---|---|---|---|---|---|---|
| Carrier | Coating | for first layer (inner side) | | | | | | | for second layer (outer side) | | | | | | |
| (1) | resin | | | | | | Resin | | | | | | | Resin | |
| Kind | Kind | Resin | Silica | Alumina | Titania | CB | particles | Toluene | Resin | Silica | Alumina | Titania | CB | particles | Toluene |
| — | — | Parts by mass | | | | | | | Parts by mass | | | | | | |
| (1-1) | (1) | 4.6 | 4.0 | — | — | 0.4 | 1.0 | 92.1 | 14.7 | 2.0 | — | — | 1.3 | 2.0 | 294.6 |
| (1-2) | (1) | 5.1 | 4.1 | — | — | 0.4 | 1.1 | 102.6 | 14.2 | 1.9 | — | — | 1.2 | 1.9 | 284.1 |
| (1-3) | (1) | 5.7 | 4.2 | — | — | 0.5 | 1.2 | 114.7 | 13.6 | 1.8 | — | — | 1.2 | 1.8 | 272.0 |
| (1-4) | (1) | 6.4 | 4.3 | — | — | 0.6 | 1.3 | 128.9 | 12.9 | 1.8 | — | — | 1.1 | 1.8 | 257.8 |
| (1-5) | (1) | 7.3 | 4.4 | — | — | 0.6 | 1.4 | 145.6 | 12.1 | 1.6 | — | — | 1.0 | 1.6 | 241.1 |
| (1-6) | (1) | 4.1 | 3.9 | — | — | 0.4 | 0.9 | 82.9 | 15.2 | 2.1 | — | — | 1.3 | 2.1 | 303.8 |
| (1-7) | (1) | 3.7 | 3.9 | — | — | 0.3 | 0.9 | 74.7 | 15.6 | 2.1 | — | — | 1.3 | 2.1 | 312.0 |
| (1-8) | (1) | 3.4 | 3.8 | — | — | 0.3 | 0.8 | 67.5 | 16.0 | 2.2 | — | — | 1.4 | 2.2 | 319.2 |
| (1-9) | (1) | 3.1 | 3.8 | — | — | 0.3 | 0.8 | 61.1 | 16.3 | 2.2 | — | — | 1.4 | 2.2 | 325.6 |
| (1-10) | (1) | 8.3 | 4.5 | — | — | 0.7 | 1.5 | 165.7 | 11.0 | 1.5 | — | — | 1.0 | 1.5 | 221.0 |
| (1-11) | (1) | 2.8 | 3.8 | — | — | 0.2 | 0.8 | 55.2 | 16.6 | 2.3 | — | — | 1.4 | 2.3 | 331.5 |
| (1-C1) | (1) | 8.9 | 5.6 | — | — | 0.8 | 1.7 | 178.4 | 10.4 | 0.4 | — | — | 0.9 | 1.3 | 208.3 |
| (1-12) | (1) | 7.6 | 5.3 | — | — | 0.7 | 1.5 | 151.9 | 11.7 | 0.8 | — | — | 1.0 | 1.5 | 234.8 |
| (1-13) | (1) | 6.3 | 4.8 | — | — | 0.5 | 1.3 | 126.9 | 13.0 | 1.2 | — | — | 1.1 | 1.7 | 259.8 |
| (1-14) | (1) | 5.2 | 4.3 | — | — | 0.4 | 1.1 | 103.3 | 14.2 | 1.7 | — | — | 1.2 | 1.9 | 283.4 |
| (1-15) | (1) | 3.5 | 3.4 | — | — | 0.3 | 0.8 | 70.7 | 15.8 | 2.6 | — | — | 1.4 | 2.2 | 316.0 |
| (1-16) | (1) | 2.5 | 2.6 | — | — | 0.2 | 0.6 | 50.8 | 16.8 | 3.4 | — | — | 1.4 | 2.4 | 335.9 |
| (1-17) | (1) | 1.6 | 1.8 | — | — | 0.1 | 0.4 | 32.4 | 17.7 | 4.2 | — | — | 1.5 | 2.6 | 354.3 |
| (1-C2) | (1) | 0.8 | 1.0 | — | — | 0.1 | 0.2 | 15.5 | 18.6 | 5.0 | — | — | 1.6 | 2.8 | 371.2 |
| (1-18) | (1) | 4.6 | 4.0 | — | — | 0.4 | 1.0 | 92.1 | 14.7 | 2.0 | — | — | 1.3 | 2.0 | 294.6 |
| (1-19) | (1) | 5.2 | — | 4.5 | — | 0.4 | 1.1 | 103.7 | 15.1 | — | 2.0 | — | 1.3 | 2.0 | 301.5 |
| (1-20) | (1) | 5.3 | — | — | 4.6 | 0.5 | 1.1 | 105.3 | 15.2 | — | — | 2.1 | 1.3 | 2.1 | 304.4 |
| (1-21) | (1) | 4.6 | 4.0 | — | — | 0.4 | 1.0 | 92.1 | 14.7 | 2.0 | — | — | 1.3 | 2.0 | 294.6 |
| (1-22) | (1) | 4.6 | 4.0 | — | — | 0.4 | 1.0 | 92.1 | 14.7 | 2.0 | — | — | 1.3 | 2.0 | 294.6 |
| (1-23) | (1) | 1.8 | 1.6 | — | — | 0.2 | 0.4 | 36.8 | 19.2 | 2.6 | — | — | 1.6 | 2.6 | 383.0 |
| (1-24) | (1) | 2.8 | 2.4 | — | — | 0.2 | 0.6 | 55.2 | 17.7 | 2.4 | — | — | 1.5 | 2.4 | 353.6 |
| (1-25) | (1) | 10.6 | 9.2 | — | — | 0.9 | 2.3 | 211.8 | 5.2 | 0.7 | — | — | 0.4 | 0.7 | 103.1 |
| (1-26) | (1) | 12.4 | 10.8 | — | — | 1.1 | 2.7 | 248.6 | 2.2 | 0.3 | — | — | 0.2 | 0.3 | 44.2 |
| (1-27) | (1) | 4.6 | 4.0 | — | — | 0.4 | 1.0 | 92.1 | 14.7 | 2.0 | — | — | 1.3 | 2.0 | 294.6 |
| (1-28) | (1) | 4.6 | 4.0 | — | — | 0.4 | 1.0 | 92.1 | 14.7 | 2.0 | — | — | 1.3 | 2.0 | 294.6 |
| (1-29) | (1) | 4.6 | 4.0 | — | — | 0.4 | 1.0 | 92.1 | 14.7 | 2.0 | — | — | 1.3 | 2.0 | 294.6 |
| (1-30) | (1) | 4.6 | 4.0 | — | — | 0.4 | 1.0 | 92.1 | 14.7 | 2.0 | — | — | 1.3 | 2.0 | 294.6 |
| (1-31) | (3) | 4.6 | 4.0 | — | — | 0.4 | 1.0 | 92.1 | 14.7 | 2.0 | — | — | 1.3 | 2.0 | 294.6 |
| (1-32) | (1) | 4.1 | 4.0 | — | — | 0.4 | 1.5 | 82.9 | 13.8 | 2.0 | — | — | 1.2 | 3.0 | 276.2 |
| (1-33) | (1) | 3.7 | 4.0 | — | — | 0.3 | 2.0 | 73.7 | 12.9 | 2.0 | — | — | 1.1 | 4.0 | 257.8 |
| (1-34) | (1) | 4.6 | 4.0 | — | — | 0.4 | 1.0 | 92.1 | 14.7 | 2.0 | — | — | 1.3 | 2.0 | 294.6 |
| (1-35) | (2) | 4.7 | 4.0 | — | — | 0.4 | 0.9 | 94.5 | 15.0 | 2.0 | — | — | 1.3 | 1.7 | 299.5 |
| (1-36) | (3) | 4.4 | 4.0 | — | — | 0.4 | 1.2 | 88.4 | 14.4 | 2.0 | — | — | 1.2 | 2.4 | 287.3 |

TABLE 1-2

| | Content of inorganic | | | | | | | | | | Particle |
|---|---|---|---|---|---|---|---|---|---|---|---|
| Carrier | particles | | Inorganic particles | | | Resin particles | | Element ratio | | | size |
| (1) | First layer | Second layer | | Particle | | | Particle | | | B(1) − | ratio |
| Kind | (inner side) | (outer side) | Kind | size D1 | Content | Kind | size D2 | A(1) | B(1) | A(1) | D1/D2 |
| — | % by mass | % by mass | — | nm | % by mass | — | nm | atm % | | | — |
| (1-1) | 40 | 10 | (S1) | 12 | 20 | (M1) | 250 | 3.5 | 5.3 | 1.8 | 0.048 |
| (1-2) | 38 | 10 | (S1) | 12 | 20 | (M1) | 250 | 3.5 | 4.7 | 1.2 | 0.048 |
| (1-3) | 36 | 10 | (S1) | 12 | 20 | (M1) | 250 | 3.5 | 4.5 | 1.0 | 0.048 |
| (1-4) | 34 | 10 | (S1) | 12 | 20 | (M1) | 250 | 3.5 | 4.3 | 0.8 | 0.048 |
| (1-5) | 32 | 10 | (S1) | 12 | 20 | (M1) | 250 | 3.5 | 4.0 | 0.5 | 0.048 |
| (1-6) | 42 | 10 | (S1) | 12 | 20 | (M1) | 250 | 3.5 | 5.8 | 2.3 | 0.048 |
| (1-7) | 44 | 10 | (S1) | 12 | 20 | (M1) | 250 | 3.5 | 6.0 | 2.5 | 0.048 |
| (1-8) | 46 | 10 | (S1) | 12 | 20 | (M1) | 250 | 3.5 | 6.2 | 2.7 | 0.048 |
| (1-9) | 48 | 10 | (S1) | 12 | 20 | (M1) | 250 | 3.5 | 6.5 | 3.0 | 0.048 |
| (1-10) | 30 | 10 | (S1) | 12 | 20 | (M1) | 250 | 3.5 | 3.9 | 0.4 | 0.048 |
| (1-11) | 50 | 10 | (S1) | 12 | 20 | (M1) | 250 | 3.5 | 6.6 | 3.1 | 0.048 |
| (1-C1) | 33 | 3 | (S1) | 12 | 20 | (M1) | 250 | 1.6 | 3.4 | 1.8 | 0.048 |
| (1-12) | 35 | 5 | (S1) | 12 | 20 | (M1) | 250 | 1.7 | 3.5 | 1.8 | 0.048 |
| (1-13) | 37 | 7 | (S1) | 12 | 20 | (M1) | 250 | 2.5 | 4.3 | 1.8 | 0.048 |
| (1-14) | 39 | 9 | (S1) | 12 | 20 | (M1) | 250 | 3.0 | 4.8 | 1.8 | 0.048 |
| (1-15) | 42 | 12 | (S1) | 12 | 20 | (M1) | 250 | 6.0 | 7.8 | 1.8 | 0.048 |
| (1-16) | 44 | 14 | (S1) | 12 | 20 | (M1) | 250 | 8.0 | 9.8 | 1.8 | 0.048 |
| (1-17) | 46 | 16 | (S1) | 12 | 20 | (M1) | 250 | 10.2 | 12.0 | 1.8 | 0.048 |
| (1-C2) | 48 | 18 | (S1) | 12 | 20 | (M1) | 250 | 11.0 | 12.8 | 1.8 | 0.048 |
| (1-18) | 40 | 10 | (Sn) | 12 | 20 | (M1) | 250 | 3.5 | 5.3 | 1.8 | 0.048 |
| (1-19) | 40 | 10 | (A) | 22 | 20 | (M1) | 250 | 3.5 | 5.3 | 1.8 | 0.088 |
| (1-20) | 40 | 10 | (T) | 20 | 20 | (M1) | 250 | 3.5 | 5.3 | 1.8 | 0.080 |
| (1-21) | 40 | 10 | (S2) | 22 | 20 | (M1) | 250 | 3.2 | 5.0 | 1.8 | 0.088 |
| (1-22) | 40 | 10 | (S3) | 12 | 20 | (M1) | 250 | 2.5 | 4.3 | 1.8 | 0.048 |
| (1-23) | 40 | 10 | (S1) | 12 | 14 | (M1) | 250 | 3.5 | 5.3 | 1.8 | 0.048 |
| (1-24) | 40 | 10 | (S1) | 12 | 15 | (M1) | 250 | 3.5 | 5.3 | 1.8 | 0.048 |
| (1-25) | 40 | 10 | (S1) | 12 | 35 | (M1) | 250 | 3.5 | 5.3 | 1.8 | 0.048 |
| (1-26) | 40 | 10 | (S1) | 12 | 37 | (M1) | 250 | 3.5 | 5.3 | 1.8 | 0.048 |
| (1-27) | 40 | 10 | (S1) | 12 | 20 | (A1) | 150 | 3.5 | 5.1 | 1.6 | 0.080 |
| (1-28) | 40 | 10 | (S7) | 65 | 20 | (M4) | 400 | 3.7 | 4.4 | 0.7 | 0.163 |
| (1-29) | 40 | 10 | (S5) | 30 | 20 | (A2) | 350 | 3.5 | 5.9 | 2.4 | 0.086 |
| (1-30) | 40 | 10 | (S6) | 40 | 20 | (M4) | 400 | 3.6 | 6.2 | 2.6 | 0.100 |
| (1-31) | 40 | 10 | (S1) | 12 | 20 | (M1) | 250 | 3.2 | 4.7 | 1.5 | 0.048 |
| (1-32) | 40 | 10 | (S1) | 12 | 20 | (M1) | 250 | 3.6 | 5.6 | 2.0 | 0.048 |
| (1-33) | 40 | 10 | (S1) | 12 | 20 | (M1) | 250 | 3.9 | 6.1 | 2.2 | 0.048 |
| (1-34) | 40 | 10 | (S4) | 7 | 20 | (M1) | 250 | 3.3 | 5.3 | 2.0 | 0.028 |
| (1-35) | 40 | 10 | (S1) | 12 | 20 | (M1) | 250 | 3.5 | 5.4 | 1.9 | 0.048 |
| (1-36) | 40 | 10 | (S1) | 12 | 20 | (M1) | 250 | 3.1 | 5.1 | 2.0 | 0.048 |

TABLE 2

| Carrier | Coating | Resin particles | | Composition of coating agent | | | | | Element ratio | | |
|---|---|---|---|---|---|---|---|---|---|---|---|
| (2) | resin | | Particle | | | | Resin | | | | B(2) − |
| Kind | Kind | Kind | size | Resin | Silica | CB | particles | Toluene | A(2) | B(2) | A(2) |
| — | — | — | nm | Parts by mass | | | | | atm % | | |
| (2-1) | (4) | (M1) | 250 | 19.4 | — | 3.1 | 2.5 | 388.0 | 0.1 | 0.3 | 0.2 |
| (2-2) | (4) | (M1) | 250 | 19.4 | 3.0 | 3.1 | 3.0 | 388.0 | 0.2 | 0.5 | 0.3 |
| (2-3) | (4) | (M1) | 250 | 19.4 | 4.0 | 3.1 | 3.0 | 388.0 | 0.3 | 0.7 | 0.4 |
| (2-4) | (4) | (M1) | 250 | 19.4 | — | 3.1 | 4.0 | 388.0 | 0.1 | 0.3 | 0.2 |
| (2-5) | (4) | (M1) | 250 | 19.4 | — | 3.1 | 1.2 | 388.0 | 0.1 | 0.3 | 0.2 |
| (2-6) | (4) | (M1) | 250 | 19.4 | — | 3.1 | 0.7 | 388.0 | 0.1 | 0.3 | 0.2 |
| (2-7) | (4) | (M1) | 250 | 19.4 | — | 3.1 | 0.9 | 388.0 | 0.1 | 0.3 | 0.2 |
| (2-8) | (4) | (M1) | 250 | 19.4 | — | 3.1 | 2.9 | 388.0 | 0.1 | 0.3 | 0.2 |

TABLE 3

| | | | | | Nitrogen | | | | | Nitrogen | | | | | | |
|---|---|---|---|---|---|---|---|---|---|---|---|---|---|---|---|---|
| | | Inorganic particles | | | atom- | | | | | atom- | | | | | | |
| | Car- | of resin coating layer | | | containing | | | | Car- | containing | | | | | | |
| | rier | | Par- | | resin | Element ratio | | | rier | resin | Element ratio | | | | | Photo- |
| | (1) | | ticle | Content | Content | | | B(1) − | (2) | Content | | | B(2) − | A(1)/ | R(1)/ | receptor |
| | Kind | Kind | size | % by | R(1) | A(1) | B(1) | A(1) | Kind | R(2) | A(2) | B(2) | A(2) | A(2) | R(2) | filming |
| | — | — | nm | mass | % by mass | atm % | | | — | % by mass | atm % | | | — | — | — |
| Example 1 | (1-1) | (S1) | 12 | 20 | 12 | 3.5 | 5.3 | 1.8 | (2-1) | 10 | 0.1 | 0.3 | 0.2 | 35 | 1.2 | A |
| Example 2 | (1-13) | (S1) | 12 | 20 | 12 | 2.5 | 4.3 | 1.8 | (2-1) | 10 | 0.1 | 0.3 | 0.2 | 25 | 1.2 | C |
| Example 3 | (1-14) | (S1) | 12 | 20 | 12 | 3.0 | 4.8 | 1.8 | (2-1) | 10 | 0.1 | 0.3 | 0.2 | 30 | 1.2 | B |
| Example 4 | (1-15) | (S1) | 12 | 20 | 12 | 6.0 | 7.8 | 1.8 | (2-1) | 10 | 0.1 | 0.3 | 0.2 | 60 | 1.2 | B |
| Example 5 | (1-16) | (S1) | 12 | 20 | 12 | 8.0 | 9.8 | 1.8 | (2-1) | 10 | 0.1 | 0.3 | 0.2 | 80 | 1.2 | C |
| Example 6 | (1-12) | (S1) | 12 | 20 | 12 | 1.7 | 3.5 | 1.8 | (2-1) | 10 | 0.1 | 0.3 | 0.2 | 17 | 1.2 | D |
| Example 7 | (1-17) | (S1) | 12 | 20 | 12 | 10.2 | 12.0 | 1.8 | (2-1) | 10 | 0.1 | 0.3 | 0.2 | 102 | 1.2 | D |
| Comparative | (1-C1) | (S1) | 12 | 20 | 12 | 1.6 | 3.4 | 1.8 | (2-1) | 10 | 0.1 | 0.3 | 0.2 | 16 | 1.2 | E |
| Example 1 | | | | | | | | | | | | | | | | |
| Comparative | (1-C2) | (S1) | 12 | 20 | 12 | 11.0 | 12.8 | 1.8 | (2-1) | 10 | 0.1 | 0.3 | 0.2 | 110 | 1.2 | E |
| Example 2 | | | | | | | | | | | | | | | | |
| Example 8 | (1-2) | (S1) | 12 | 20 | 12 | 3.5 | 4.7 | 1.2 | (2-1) | 10 | 0.1 | 0.3 | 0.2 | 35 | 1.2 | A |
| Example 9 | (1-3) | (S1) | 12 | 20 | 12 | 3.5 | 4.5 | 1.0 | (2-1) | 10 | 0.1 | 0.3 | 0.2 | 35 | 1.2 | B |
| Example 10 | (1-4) | (S1) | 12 | 20 | 12 | 3.5 | 4.3 | 0.8 | (2-1) | 10 | 0.1 | 0.3 | 0.2 | 35 | 1.2 | B− |
| Example 11 | (1-5) | (S1) | 12 | 20 | 12 | 3.5 | 4.0 | 0.5 | (2-1) | 10 | 0.1 | 0.3 | 0.2 | 35 | 1.2 | C |
| Example 12 | (1-6) | (S1) | 12 | 20 | 12 | 3.5 | 5.8 | 2.3 | (2-1) | 10 | 0.1 | 0.3 | 0.2 | 35 | 1.2 | A |
| Example 13 | (1-7) | (S1) | 12 | 20 | 12 | 3.5 | 6.0 | 2.5 | (2-1) | 10 | 0.1 | 0.3 | 0.2 | 35 | 1.2 | B |
| Example 14 | (1-8) | (S1) | 12 | 20 | 12 | 3.5 | 6.2 | 2.7 | (2-1) | 10 | 0.1 | 0.3 | 0.2 | 35 | 1.2 | B− |
| Example 15 | (1-9) | (S1) | 12 | 20 | 12 | 3.5 | 6.5 | 3.0 | (2-1) | 10 | 0.1 | 0.3 | 0.2 | 35 | 1.2 | C |
| Example 16 | (1-10) | (S1) | 12 | 20 | 12 | 3.5 | 3.9 | 0.4 | (2-1) | 10 | 0.1 | 0.3 | 0.2 | 35 | 1.2 | C− |
| Example 17 | (1-11) | (S1) | 12 | 20 | 12 | 3.5 | 6.6 | 3.1 | (2-1) | 10 | 0.1 | 0.3 | 0.2 | 35 | 1.2 | C− |
| Example 18 | (1-15) | (S1) | 12 | 20 | 12 | 6.0 | 7.8 | 1.8 | (2-2) | 9 | 0.2 | 0.5 | 0.3 | 30 | 1.3 | B |
| Example 19 | (1-16) | (S1) | 12 | 20 | 12 | 8.0 | 9.8 | 1.8 | (2-3) | 9 | 0.3 | 0.7 | 0.4 | 27 | 1.3 | C |
| Example 20 | (1-18) | (Sn) | 12 | 20 | 12 | 3.5 | 5.3 | 1.8 | (2-1) | 10 | 0.1 | 0.3 | 0.2 | 35 | 1.2 | B |
| Example 21 | (1-19) | (A) | 22 | 20 | 12 | 3.5 | 5.3 | 1.8 | (2-1) | 10 | 0.1 | 0.3 | 0.2 | 35 | 1.2 | B |
| Example 22 | (1-20) | (T) | 20 | 20 | 12 | 3.5 | 5.3 | 1.8 | (2-1) | 10 | 0.1 | 0.3 | 0.2 | 35 | 1.2 | B |
| Example 23 | (1-21) | (S2) | 22 | 20 | 12 | 3.2 | 5.0 | 1.8 | (2-1) | 10 | 0.1 | 0.3 | 0.2 | 32 | 1.2 | B+ |
| Example 24 | (1-22) | (S3) | 12 | 20 | 12 | 2.5 | 4.3 | 1.8 | (2-1) | 10 | 0.1 | 0.3 | 0.2 | 25 | 1.2 | C− |
| Example 25 | (1-34) | (S4) | 7 | 20 | 12 | 3.3 | 5.3 | 2.0 | (2-1) | 10 | 0.1 | 0.3 | 0.2 | 33 | 1.2 | A |
| Example 26 | (1-29) | (S5) | 30 | 20 | 12 | 3.5 | 5.9 | 2.4 | (2-1) | 10 | 0.1 | 0.3 | 0.2 | 35 | 1.2 | B+ |
| Example 27 | (1-30) | (S6) | 40 | 20 | 12 | 3.6 | 6.2 | 2.6 | (2-1) | 10 | 0.1 | 0.3 | 0.2 | 36 | 1.2 | B |
| Example 28 | (1-28) | (S7) | 65 | 20 | 12 | 3.7 | 4.4 | 0.7 | (2-1) | 10 | 0.1 | 0.3 | 0.2 | 37 | 1.2 | D |
| Example 29 | (1-23) | (S1) | 12 | 14 | 12 | 3.5 | 5.3 | 1.8 | (2-1) | 10 | 0.1 | 0.3 | 0.2 | 35 | 1.2 | C |
| Example 30 | (1-24) | (S1) | 12 | 15 | 11 | 3.5 | 5.3 | 1.8 | (2-1) | 10 | 0.1 | 0.3 | 0.2 | 35 | 1.1 | B |
| Example 31 | (1-25) | (S1) | 12 | 35 | 12 | 3.5 | 5.3 | 1.8 | (2-1) | 10 | 0.1 | 0.3 | 0.2 | 35 | 1.2 | B |
| Example 32 | (1-26) | (S1) | 12 | 37 | 11 | 3.5 | 5.3 | 1.8 | (2-1) | 10 | 0.1 | 0.3 | 0.2 | 35 | 1.1 | C |
| Example 33 | (1-27) | (S1) | 12 | 20 | 2 | 3.5 | 5.1 | 1.6 | (2-1) | 10 | 0.1 | 0.3 | 0.2 | 35 | 0.2 | B |
| Example 34 | (1-27) | (S1) | 12 | 20 | 2 | 3.5 | 5.1 | 1.6 | (2-4) | 16 | 0.1 | 0.3 | 0.2 | 35 | 0.1 | C |
| Example 35 | (1-27) | (S1) | 12 | 20 | 2 | 3.5 | 5.1 | 1.6 | (2-5) | 5 | 0.1 | 0.3 | 0.2 | 35 | 0.4 | B+ |
| Example 36 | (1-31) | (S1) | 12 | 20 | 10 | 3.2 | 4.7 | 1.5 | (2-4) | 16 | 0.1 | 0.3 | 0.2 | 32 | 0.6 | B+ |
| Example 37 | (1-32) | (S1) | 12 | 20 | 17 | 3.6 | 5.6 | 2.0 | (2-1) | 10 | 0.1 | 0.3 | 0.2 | 36 | 1.7 | A |
| Example 38 | (1-33) | (S1) | 12 | 20 | 22 | 3.9 | 6.1 | 2.2 | (2-4) | 16 | 0.1 | 0.3 | 0.2 | 39 | 1.4 | A |
| Example 39 | (1-32) | (S1) | 12 | 20 | 17 | 3.6 | 5.6 | 2.0 | (2-5) | 5 | 0.1 | 0.3 | 0.2 | 36 | 3.4 | B |
| Example 40 | (1-33) | (S1) | 12 | 20 | 22 | 3.9 | 6.1 | 2.2 | (2-5) | 5 | 0.1 | 0.3 | 0.2 | 39 | 4.4 | C |
| Example 41 | (1-1) | (S1) | 12 | 20 | 12 | 3.5 | 5.3 | 1.8 | (2-6) | 3 | 0.1 | 0.3 | 0.2 | 35 | 4.0 | B |
| Example 42 | (1-2) | (S1) | 12 | 20 | 12 | 3.5 | 4.7 | 1.2 | (2-7) | 4 | 0.1 | 0.3 | 0.2 | 35 | 3.0 | B+ |
| Example 43 | (1-3) | (S1) | 12 | 20 | 12 | 3.5 | 4.5 | 1.0 | (2-8) | 12 | 0.1 | 0.3 | 0.2 | 35 | 1.0 | A |
| Example 44 | (1-35) | (S1) | 12 | 20 | 12 | 3.5 | 5.4 | 1.9 | (2-1) | 10 | 0.1 | 0.3 | 0.2 | 35 | 1.2 | B+ |
| Example 45 | (1-36) | (S1) | 12 | 20 | 12 | 3.1 | 5.1 | 2.0 | (2-1) | 10 | 0.1 | 0.3 | 0.2 | 31 | 1.2 | B |

The electrostatic charge image developer set, image forming apparatus, and image forming method of the present disclosure include the following aspects.

### APPENDIX

(((1)))

An electrostatic charge image developer set comprising:
a developer (1) and a developer (2) each containing a toner and a carrier, wherein
a carrier (1) of the developer (1) includes magnetic particles, a resin coating layer that covers the magnetic particles, and inorganic particles contained in the resin coating layer,
a carrier (2) of the developer (2) includes magnetic particles and a resin coating layer that covers the magnetic particles, and
a value of A(1)/A(2) is 17 or more and 105 or less, where when an element ratio of a metal and a semimetal that constitute the inorganic particles of the carrier (1) is analyzed by X-ray photoelectron spectroscopy for each of the carrier (1) and the carrier (2), an element ratio on a surface of the carrier (1) is denoted as A(1) and an element ratio on a surface of the carrier (2) is denoted as A(2).
   (((2)))

The electrostatic charge image developer set according to (((1))), wherein
a value of B(1)−A(1) in the carrier (1) is 0.5 atm % or more and 3.0 atm % or less, where when an element ratio of a metal and a semimetal that constitute the inorganic particles of the carrier (1) is analyzed in a depth direction by X-ray photoelectron spectroscopy, an element ratio at an etching time of 0 seconds is denoted as A(1) and an element ratio at an etching time of 300 seconds is denoted as B(1).
   (((3)))

The electrostatic charge image developer set according to (((1))) or (((2))), wherein
a value of B(2)−A(2) in the carrier (2) is 0.3 atm % or less, where when an element ratio of a metal and a semimetal that constitute the inorganic particles of the carrier (1) is analyzed in a depth direction by X-ray photoelectron spectroscopy, an element ratio at an etching time of 0 seconds is denoted as A(2) and an element ratio at an etching time of 300 seconds is denoted as B(2).
   (((4)))

The electrostatic charge image developer set according to any one of (((1))) to (((3))), wherein
the inorganic particles of the carrier (1) include at least one selected from the group consisting of silica particles, alumina particles, and titania particles.
   (((5)))

The electrostatic charge image developer set according to any one of (((1))) to (((4))), wherein
a volume average particle size of the inorganic particles contained in the resin coating layer of the carrier (1) is 5 nm or more and 40 nm or less.
   (((6)))

The electrostatic charge image developer set according to any one of (((1))) to (((5))), wherein
a mass proportion of the inorganic particles in the resin coating layer of the carrier (1) is 15% by mass or more and 35% by mass or less.
   (((7)))

The electrostatic charge image developer set according to any one of (((1))) to (((6))), wherein
when the carrier (1) contains a nitrogen atom-containing resin in the resin coating layer and a mass proportion of the nitrogen atom-containing resin in the resin coating layer is denoted as R(1) and
the carrier (2) contains a nitrogen atom-containing resin in the resin coating layer and a mass proportion of the nitrogen atom-containing resin in the resin coating layer is denoted as R(2),
a value of R(1)/R(2) is 0.2 or more and 4.0 or less.
   (((8)))

An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to any one of (((1))) to (((7))) is accommodated,
the developer (1) is accommodated in a developing device of each of the first image forming unit, the second image forming unit, and the third image forming unit, and
the developer (2) is accommodated in a developing device of the fourth image forming unit.
   (((9)))

An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to any one of (((1))) to (((7))) is used,
the developer (1) is used in a developing step of each of the first image forming step, the second image forming step, and the third image forming step, and
the developer (2) is used in a developing step of the fourth image forming step.

What is claimed is:

1. An electrostatic charge image developer set comprising:
a developer (1) and a developer (2) each containing a toner and a carrier, wherein
a carrier (1) of the developer (1) includes magnetic particles, a resin coating layer that covers the magnetic particles, and inorganic particles contained in the resin coating layer,
a carrier (2) of the developer (2) includes magnetic particles and a resin coating layer that covers the magnetic particles, and
a value of A(1)/A(2) is 17 or more and 105 or less, where when an element ratio of a metal and a semimetal that constitute the inorganic particles of the carrier (1) is analyzed by X-ray photoelectron spectroscopy for each of the carrier (1) and the carrier (2), an element ratio on a surface of the carrier (1) is denoted as A(1) and an element ratio on a surface of the carrier (2) is denoted as A(2).

2. The electrostatic charge image developer set according to claim 1, wherein
a value of B(1)−A(1) in the carrier (1) is 0.5 atm % or more and 3.0 atm % or less, where when an element ratio of a metal and a semimetal that constitute the inorganic particles of the carrier (1) is analyzed in a depth direction by X-ray photoelectron spectroscopy, an element ratio at an etching time of 0 seconds is denoted as A(1) and an element ratio at an etching time of 300 seconds is denoted as B(1).

3. The electrostatic charge image developer set according to claim 1, wherein
a value of B(2)−A(2) in the carrier (2) is 0.3 atm % or less, where when an element ratio of a metal and a semimetal that constitute the inorganic particles of the carrier (1) is analyzed in a depth direction by X-ray photoelectron spectroscopy, an element ratio at an etching time of 0 seconds is denoted as A(2) and an element ratio at an etching time of 300 seconds is denoted as B(2).

4. The electrostatic charge image developer set according to claim 1, wherein
the inorganic particles of the carrier (1) include at least one selected from the group consisting of silica particles, alumina particles, and titania particles.

5. The electrostatic charge image developer set according to claim 1, wherein
a volume average particle size of the inorganic particles contained in the resin coating layer of the carrier (1) is 5 nm or more and 40 nm or less.

6. The electrostatic charge image developer set according to claim 1, wherein
a mass proportion of the inorganic particles in the resin coating layer of the carrier (1) is 15% by mass or more and 35% by mass or less.

7. The electrostatic charge image developer set according to claim 1, wherein
when the carrier (1) contains a nitrogen atom-containing resin in the resin coating layer and a mass proportion of the nitrogen atom-containing resin in the resin coating layer is denoted as R(1) and
the carrier (2) contains a nitrogen atom-containing resin in the resin coating layer and a mass proportion of the nitrogen atom-containing resin in the resin coating layer is denoted as R(2),
a value of R(1)/R(2) is 0.2 or more and 4.0 or less.

8. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 1 is accommodated,
the developer (1) is accommodated in a developing device of each of the first image forming unit, the second image forming unit, and the third image forming unit, and
the developer (2) is accommodated in a developing device of the fourth image forming unit.

9. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 2 is accommodated,
the developer (1) is accommodated in a developing device of each of the first image forming unit, the second image forming unit, and the third image forming unit, and
the developer (2) is accommodated in a developing device of the fourth image forming unit.

10. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 3 is accommodated,
the developer (1) is accommodated in a developing device of each of the first image forming unit, the second image forming unit, and the third image forming unit, and
the developer (2) is accommodated in a developing device of the fourth image forming unit.

11. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 4 is accommodated,
the developer (1) is accommodated in a developing device of each of the first image forming unit, the second image forming unit, and the third image forming unit, and
the developer (2) is accommodated in a developing device of the fourth image forming unit.

12. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 5 is accommodated,
the developer (1) is accommodated in a developing device of each of the first image forming unit, the second image forming unit, and the third image forming unit, and
the developer (2) is accommodated in a developing device of the fourth image forming unit.

13. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 6 is accommodated,
the developer (1) is accommodated in a developing device of each of the first image forming unit, the second image forming unit, and the third image forming unit, and
the developer (2) is accommodated in a developing device of the fourth image forming unit.

14. An image forming apparatus comprising:
a first image forming unit configured to form a yellow image;
a second image forming unit configured to form a magenta image;
a third image forming unit configured to form a cyan image; and
a fourth image forming unit configured to form a black image, wherein
the electrostatic charge image developer set according to claim 7 is accommodated,
the developer (1) is accommodated in a developing device of each of the first image forming unit, the second image forming unit, and the third image forming unit, and
the developer (2) is accommodated in a developing device of the fourth image forming unit.

15. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 1 is used,
the developer (1) is used in a developing step of each of the first image forming step, the second image forming step, and the third image forming step, and
the developer (2) is used in a developing step of the fourth image forming step.

16. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 2 is used,
the developer (1) is used in a developing step of each of the first image forming step, the second image forming step, and the third image forming step, and
the developer (2) is used in a developing step of the fourth image forming step.

17. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 3 is used,
the developer (1) is used in a developing step of each of the first image forming step, the second image forming step, and the third image forming step, and
the developer (2) is used in a developing step of the fourth image forming step.

18. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 4 is used,
the developer (1) is used in a developing step of each of the first image forming step, the second image forming step, and the third image forming step, and
the developer (2) is used in a developing step of the fourth image forming step.

19. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 5 is used,
the developer (1) is used in a developing step of each of the first image forming step, the second image forming step, and the third image forming step, and
the developer (2) is used in a developing step of the fourth image forming step.

20. An image forming method comprising:
a first image forming step of forming a yellow image;
a second image forming step of forming a magenta image;
a third image forming step of forming a cyan image; and
a fourth image forming step of forming a black image, wherein
the electrostatic charge image developer set according to claim 6 is used,
the developer (1) is used in a developing step of each of the first image forming step, the second image forming step, and the third image forming step, and
the developer (2) is used in a developing step of the fourth image forming step.
